(19) United States
(12) Patent Application Publication
(10) Pub. No.: US 2025/0084542 A1
(43) Pub. Date: Mar. 13, 2025

(54) USE OF A POROUS RECYCLING LAYER FOR CO2 ELECTROREDUCTION TO MULTICARBON PRODUCTS WITH HIGH CONVERSION EFFICIENCY

(71) Applicant: THE GOVERNING COUNCIL OF THE UNIVERSITY OF TORONTO, Toronto, Ontario (CA)

(72) Inventors: Colin O'BRIEN, Toronto, Ontario (CA); Rui Kai MIAO, Toronto, Ontario (CA); David SINTON, Toronto, Ontario (CA); Edward SARGENT, Toronto, Ontario (CA)

(21) Appl. No.: 18/292,511

(22) PCT Filed: Jul. 27, 2022
(86) PCT No.: PCT/CA2022/051153

§ 371 Date: Jan. 26, 2024

Related U.S. Application Data
(60) Provisional application No. 63/203,559, filed on Jul. 27, 2021.

(51) Int. Cl. C25B 9/23; C25B 3/03; C25B 3/07; C25B 3/26; C25B 11/032; C25B 11/081; C25B 13/02; C25B 15/08

(52) U.S. Cl. CPC C25B 9/23; C25B 3/03; C25B 3/07; C25B 3/26; C25B 11/032; C25B 11/081; C25B 13/02; C25B 15/087

(57) ABSTRACT

Multilayer cathodes for the electrochemical reduction of carbon dioxide as well as membrane electrode assemblies and bipolar membrane electrode assemblies comprising the multilayer cathodes are described. More particularly, the multilayer cathodes for the electrochemical reduction of carbon dioxide comprise a gas diffusion layer, a cathode catalyst layer disposed on the gas diffusion layer, and a permeable carbon dioxide regeneration layer comprising an anion exchange ionomer disposed on the cathode catalyst layer. The uses of the multilayer cathodes, the membrane electrode assemblies and the bipolar membrane electrode assemblies for the production of multicarbon products as well as their processes of manufacturing are also described. Finally, also described are methods for electrochemical production of a multicarbon product using the multilayer cathodes, the membrane electrode assemblies and the bipolar membrane electrode assemblies.

### RELATED APPLICATION

This application claims priority under applicable laws to U.S. provisional application No. 63/203,559 filed on Jul. 27, 2021, the content of which is incorporated herein by reference in its entirety for all purposes.

### TECHNICAL FIELD

The technical field generally relates to electrolytic carbon dioxide (CO₂) reduction, and more specifically to systems and methods for the production of multicarbon products via the electrocatalytic CO₂ reduction reaction (CO₂RR).

### BACKGROUND

The electrochemical CO₂RR presents the opportunity to consume CO₂ and produce desirable products such as multicarbon (C₂₊) products. However, the alkaline conditions required for productive CO₂RR result in the bulk of input CO₂ being lost to bicarbonate and carbonate. This loss imposes a limit of 25% conversion in the conversion of CO₂ to multicarbon products for systems that use anions as the charge carrier and overcoming this limit is a challenge of singular importance to the field.

Accordingly, there is a need for improved techniques and ion exchange materials for membrane electrode assembly (MEA) systems that overcome one or more of the disadvantages encountered with conventional MEA systems and methods for the conversion of CO₂ to multicarbon products.

### SUMMARY

According to a first aspect, the present technology relates to a multilayer cathode for the electrochemical reduction of carbon dioxide comprising:
a gas diffusion layer;
a cathode catalyst layer disposed on the gas diffusion layer, and
a permeable carbon dioxide regeneration layer comprising an anion exchange ionomer disposed on the cathode catalyst layer.

According to another aspect, the present technology relates to a method of manufacturing a multilayer cathode for the electrochemical reduction of carbon dioxide comprising:
depositing a cathode catalyst material onto one side of a gas diffusion layer to provide a cathode catalyst layer thereon; and
coating an anion exchange ionomer solution onto the cathode catalyst layer to provide a permeable carbon dioxide regeneration layer.

According to another aspect, the present technology relates to a membrane electrode assembly for the electrochemical reduction of carbon dioxide comprising:
a multilayer cathode comprising a gas diffusion layer, a cathode catalyst layer disposed on the gas diffusion layer, and a permeable carbon dioxide regeneration layer comprising an anion exchange ionomer disposed on the cathode catalyst layer;
an anode comprising an anode catalyst layer; and
at least one layer of a cation exchange membrane disposed between the permeable carbon dioxide regeneration layer and the anode catalyst layer.

According to another aspect, the present technology relates to a bipolar membrane electrode assembly for the electrochemical reduction of carbon dioxide comprising:
a multilayer cathode comprising a gas diffusion layer, a cathode catalyst layer disposed on the gas diffusion layer, and a permeable carbon dioxide regeneration layer comprising an anion exchange ionomer disposed on the cathode catalyst layer;
an anode comprising an anode catalyst layer; and
at least one layer of a cation exchange membrane and at least one layer of an anion exchange membrane disposed between the permeable carbon dioxide regeneration layer and the anode catalyst layer, wherein said at least one layer of a cation exchange membrane faces the permeable carbon dioxide regeneration layer and said at least one layer of an anion exchange membrane faces the anode catalyst layer.

According to another aspect, the present technology relates to a method of manufacturing a membrane electrode assembly for the electrochemical reduction of carbon dioxide comprising:
depositing a cathode catalyst material onto one side of a gas diffusion layer to provide a cathode catalyst layer thereon;
coating an anion exchange ionomer solution onto the cathode catalyst layer to provide a permeable carbon dioxide regeneration layer;
placing at least one layer of a cation exchange membrane onto the permeable carbon dioxide regeneration layer; and
placing an anode comprising on one side an anode catalyst material onto the at least one layer of a cation exchange membrane, said anode catalyst material facing the at least one layer of a cation exchange membrane.

According to another aspect, the present technology relates to a method of manufacturing a bipolar membrane electrode assembly for the electrochemical reduction of carbon dioxide comprising:
depositing a cathode catalyst material onto one side of a gas diffusion layer to provide a cathode catalyst layer thereon;
coating an anion exchange ionomer solution onto the cathode catalyst layer to provide a permeable carbon dioxide regeneration layer;
placing at least one layer of a cation exchange membrane onto the permeable carbon dioxide regeneration layer;
placing at least one layer of an anion exchange membrane onto the at least one layer of a cation exchange membrane; and
placing an anode comprising on one side an anode catalyst material onto the at least one layer of an anion exchange membrane, said anode catalyst material facing the at least one layer of an anion exchange membrane.

According to another aspect, the present technology relates to a use of the multilayer cathode as defined herein or produced by the method as defined herein, for the production of a multicarbon product.

According to another aspect, the present technology relates to a use of the membrane electrode assembly as defined herein or produced by the method as defined herein, for the production of a multicarbon product.

According to another aspect, the present technology relates to a use of the bipolar membrane electrode assembly as defined herein or produced by the method as defined herein, for the production of a multicarbon product.

In one embodiment, the multicarbon product is ethylene or ethanol.

According to another aspect, the present technology relates to a method for electrochemical production of a multicarbon product using the bipolar membrane electrode assembly as defined herein, the method comprising the steps of:
contacting carbon dioxide and an electrolyte with the multilayer cathode, such that the carbon dioxide diffuses through the gas diffusion layer and contacts the cathode catalyst layer;
applying a voltage to provide a current density to cause the carbon dioxide contacting the cathode catalyst layer to be electrochemically reduced into the multicarbon product; and recovering the multicarbon product.

In one embodiment, carbonate ions are produced when applying the voltage.

In another embodiment, carbon dioxide is regenerated from the carbonate ions in the permeable carbon dioxide regeneration layer.

In another embodiment, the regenerated carbon dioxide is transported to the cathode catalyst layer to be electrochemically reduced into the multicarbon product prior to the recovering step.

In another embodiment, the multicarbon product is ethylene or ethanol.

According to another aspect, the present technology relates to a method for electrochemical production of a multicarbon product using the membrane electrode assembly as defined herein, the method comprising the steps of:
contacting carbon dioxide and an electrolyte with the multilayer cathode, such that the carbon dioxide diffuses through the gas diffusion layer and contacts the cathode catalyst layer;
applying a voltage to provide a current density to cause the carbon dioxide contacting the cathode catalyst layer to be electrochemically reduced into the multicarbon product; and
recovering the multicarbon product.

In one embodiment, carbonate ions are produced when applying the voltage.

In another embodiment, carbon dioxide is regenerated from the carbonate ions in the permeable carbon dioxide regeneration layer.

In another embodiment, the regenerated carbon dioxide is transported to the cathode catalyst layer to be electrochemically reduced into the multicarbon product prior to the recovering step.

In another embodiment, the multicarbon product is ethylene or ethanol.

### BRIEF DESCRIPTION OF DRAWINGS

FIG. 1 is a schematic representation of a MEA system according to one embodiment.

FIG. 2 is a schematic representation of a bipolar membrane electrode assembly (BPMEA) system according to one embodiment.

FIG. 3A is a schematic representation of a MEA system with an anion exchange membrane (AEM) showing the distribution of CO₂ while operating at 150 mA/cm² and 6 sccm of CO₂ flow, as described in Example 6(a).

FIG. 3B is a graph showing the CO₂ distribution as a function of the CO₂ flow rate for the MEA cell with an AEM at 150 mA/cm², as described in Example 6(a).

FIG. 4A is a graph showing the faradaic efficiency for various multicarbon products and CO₂ conversion efficiency as a function of the CO₂ flow rate for the MEA cell with an AEM at 150 mA/cm², as described in Example 6(a).

FIG. 4B is a graph showing the cell voltage as a function of the CO₂ flow rate for the MEA cell with an AEM at 150 mA/cm², as described in Example 6(a).

FIG. 4C is a graph showing the CO₂ conversion efficiency with and without carbonate formation as a function of the CO₂ flow rate for the MEA cell with an AEM at 150 mA/cm², as described in Example 6(a).

FIG. 5A is a schematic representation of species transport within a MEA with a cation exchange membrane (CEM), as described in Example 6(b).

FIG. 5B is a graph showing the anode gas CO₂ flow rate as a function of the current density for the MEA cell with a CEM, as described in Example 6(b). Error bars represent the standard deviation of at least three measurements obtained under the same conditions.

FIG. 5C is a graph showing the H₂ faradaic efficiency as a function of the current density for the MEA cell with a CEM, as described in Example 6(b). Error bars represent the standard deviation of at least three measurements obtained under the same conditions.

FIG. 6 is a graph showing the current density as a function of the cell voltage for the MEA cell with a CEM, as described in Example 6(b). The selectivity data is shown in FIG. 5C, only H₂ was detected and there are no traces of CO₂RR products.

FIG. 7A is a schematic representation of species transport within a MEA with a forward bias BPM, as described in Example 6(c).

FIG. 7B is a graph showing the C₂H₄ faradaic efficiency and voltage stability as a function of time for the MEA cell with a forward bias BPM at 50 mA/cm², as described in Example 6(c).

FIG. 7C is a picture of the BPM after operating in the forward bias for 2 hours at 50 mA/cm², as described in Example 6(c). The membrane blistered at the AEM: CEM interface in the areas under the flow channels of the cell.

FIG. 8 is a graph showing the electrochemical performances of the MEA cell with a forward bias BPM, effectively a graph comparing the anode gas CO₂ flow rate as a function of the current density for the MEA cell with an AEM, a CEM, a permeable CO₂ regeneration layer (PCRL) and a forward bias BPM, as described in Example 6(c). Error bars represent the standard deviation of at least three measurements obtained under the same conditions.

FIG. 9 shows in (A) a scanning electron microscopy (SEM) image of a cathode including a copper catalyst sputtered on a polytetrafluoroethylene (PTFE) filter without a PCRL coating, in (B) a cross-section SEM image of the cathode with 1.5 mg/cm² of PCRL coating, and in (C) an optical microscope image of the surface of the cathode with 1.5 mg/cm² of PCRL coating at 10× magnification, as described in Example 6(d). Scale bars represent 500 nm, 5 μm and 50 μm, respectively.

FIG. 10A to 10E show respectively SEM images of cathodes including a copper catalyst sputtered on a PTFE filter with PCRL loadings of 0 mg/cm², 0.75 mg/cm², 1.5 mg/cm², 2.25 mg/cm², and 3.0 mg/cm², as described in Example 6(d). Scale bars represent 10 μm.

FIG. 11 shows in (A) polarization curves with three different PCRL loadings on a copper catalyst, in (B) a bar graph showing the highest C₂H₄ faradaic efficiency and C₂H₄ to H₂ ratio for four different PCRL loadings, in (C) a bar graph showing the gas product faradaic efficiency for a copper catalyst with a 2.25 mg/cm² PCRL coating as a function of the cell voltage, in (D) a graph comparing the anode gas CO₂ flow rate for the PCRL compared to the AEM and CEM cells, in (E) a graph showing the CO₂ flow distribution with the 2.25 mg/cm² of PCRL coating as a function of the input CO₂ flow rate at 100 mA/cm² and in (F) a bar graph showing the CO₂ conversion efficiency with the 2.25 mg/cm² of PCRL loading with varying CO₂ flow rates at 100 mA/cm², as described in Example 6(d). Error bars represent the standard deviation of at least three measurements obtained under the same conditions.

FIG. 12 is a graph showing the ohmic resistance as a function of PCRL loading obtained for a PCRL-coupled CEM at 100 mA/cm², as described in Example 6(d). Error bars represent the standard deviation of three samples measurements obtained under the same conditions.

FIG. 13 is a graph showing the pH in the cell obtained with the one-dimensional multiphysics model at varying coating thicknesses and current densities, as described in Example 6(d). The pH at 30 mA/cm² is not adequately alkaline for more than 5% faradaic efficiency to multicarbon products. The coating thicknesses are estimated from cross-sectional SEM images.

FIGS. 14A to 14D are respectively a graph bar showing the gas product faradaic efficiency for 0.75 mg/cm², 1.5 mg/cm², 2.25 mg/cm², and 3.0 mg/cm² loadings at varying cell voltages, as described in Example 6(d).

FIGS. 15A to 15C are respectively a graph bar showing the CO₂ conversion efficiency and the faradaic efficiency for 50 mA/cm², 100 mA/cm² and 150 mA/cm² at varying CO₂ flow rates, as described in Example 6(d). A cathode with a PCRL loading of 2.25 mg/cm² was used.

FIG. 16 is a graph showing the linear gas velocity and Reynolds number of the CO₂ flow in the cell, as described in Example 6(d).

FIG. 17 is a graph showing the C₂H₄ faradaic efficiency and cell voltage as a function of time, effectively showing the stability of the PCRL-coupled CEM, as described in Example 6(d). A loading of 2.25 mg/cm² PCRL on a copper catalyst at 100 mA/cm² was run with 0.01 M H₂SO₄ anolyte. A mildly acidic anolyte was employed to maintain a constant anolyte pH over long times, accommodating any produced HCOOH or CH₃COOH that diffuses into the anolyte.

FIG. 18 is a graph showing the faradaic efficiency and current density for a silver catalyst with a 2.25 mg/cm² PCRL coating at varying cell voltages, as described in Example 6(d).

FIG. 19 is a bar graph comparing the energy cost required for downstream CO₂ separation from the cathode and anode gas product streams for a MEA with an AEM and a PCRL-coupled CEM, as described in Example 6(d). The C₂H₄ Gibbs free energy of reaction (1331 KJ/mol) is shown for reference. A CO₂ capture energy intensity of 178.3 KJ/mol CO₂ was applied, based on amine-based capture of CO₂ from flue gas.¹

### DETAILED DESCRIPTION

The following detailed description and examples are illustrative and should not be interpreted as further limiting the scope of the invention. On the contrary, it is intended to cover all alternatives, modifications and equivalents that can be included as defined by the present description. The objects, advantages and other features of the methods will be more apparent and better understood upon reading the following non-restrictive description and references made to the accompanying drawings.

All technical and scientific terms and expressions used herein have the same definitions as those commonly understood by the person skilled in the art when relating to the present technology. The definition of some terms and expressions used herein is nevertheless provided below for clarity purposes.

When the term “about” are used herein, it means approximately, in the region of or around. When the term “about” is used in relation to a numerical value, it modifies it; for example, by a variation of 10% above and below its nominal value. This term can also take into account the rounding of a number or the probability of random errors in experimental measurements, for instance, due to equipment limitations.

When a range of values is mentioned in the present application, the lower and upper limits of the range are, unless otherwise indicated, always included in the definition. When a range of values is mentioned in the present application, then all intermediate ranges and subranges, as well as individual values included in the ranges, are intended to be included.

It is worth mentioning that throughout the following description when the article “a” is used to introduce an element, it does not have the meaning of “only one” and rather means “one or more”. It is to be understood that where the specification states that a step, component, feature, or characteristic “may”, “might”, “can” or “could” be included, that particular component, feature or characteristic is not required to be included in all alternatives.

When the term “comprising” or its equivalent terms “including” or “having” are used herein, it does not exclude other elements. For the purposes of the present invention, the expression “consisting of” is considered to be a preferred embodiment of the term “comprising”. If a group is defined hereinafter to include at least a certain number of embodiments, it is also to be understood to disclose a group, which preferably consists only of these embodiments.

Various ion exchange materials for MEA systems and methods described herein are related to the production of multicarbon products via the electrocatalytic CO₂RR.

The electrochemical CO₂RR presents an opportunity to utilize renewable electricity to produce chemical fuels and feedstocks from CO₂.^{2,3} Valuable multicarbon (C₂₊) products, such as ethylene (C₂H₄) and ethanol (C₂H₅OH), are of particular interest in view of large existing markets.⁴ Providing reactant CO₂ gas directly to the catalyst sites with gas diffusion electrodes enables CO₂RR systems to attain impressive reactions rates (>>100 mA/cm²).^{5,6}

MEA cells combine GDEs and membranes in a zero-gap fashion.⁷⁻¹⁰ This configuration mitigates electrolyte degradation and salt precipitation issues characteristic of alkaline flow cells. Alkaline conditions are required at the cathode¹¹ to suppress the hydrogen evolution reaction (HER) and enable a high faradaic efficiency towards CO₂RR products.^{12,13} Locally alkaline conditions are maintained during CO₂RR by hydroxide anions produced at the catalyst layer (Equations 1 and 2).¹⁴ However, these conditions result in the competing reaction of CO₂ with hydroxide forming bicarbonate and carbonate (Equations 3 and 4). These ions electromigrate through the AEM to the anode where they combine with protons generated by the anodic oxygen evolution reaction to form CO₂ and water.¹⁴ Here the CO₂ bubbles out of the locally acidic anolyte and combines with produced oxygen, rendering a gas mixture that is costly to separate.¹⁵ This crossover of CO₂ in MEA systems results in a low single pass conversion for CO₂RR. When carbonate is the dominant charge carrier through the AEM, CO₂ conversion efficiency is limited to 50% in the production of CO.¹⁶⁻¹⁸

$${CO}_{2} + {H}_{2} O + 2 {e}^{-} \to CO + 2 O {H}^{-} \qquad ( eq . 1 )$$

$$2 {CO}_{2} + 8 {H}_{2} O + 12 {e}^{-} \to {C}_{2} {H}_{4} + 12 {OH}^{-} \qquad ( eq . 2 )$$

$${CO}_{2} + {OH}^{-} \to {HCO}_{3}^{-} \qquad ( eq . 3 )$$

$${CO}_{2} + 2 {OH}^{-} \to {CO}_{3}^{2 -} + {H}_{2} O \qquad ( eq . 4 )$$

Compared to CO production, multicarbon production requires more electrons to be transferred through the membrane per molecule of CO₂ converted (Equations 1 and 2): the dominant multicarbon products on a multicrystalline copper catalyst, C₂H₄ and C₂H₅OH, both require 6 electrons per CO₂ molecule converted. With a carbonate charge carrier, three molecules of CO₂ will be transported through the membrane for each molecule of CO₂ converted to C₂H₄ or C₂H₅OH, limiting the CO₂ conversion efficiency to a maximum of 25%. A low CO₂ conversion efficiency necessitates energy-intensive gas separation to recover unreacted CO₂ from both the cathodic and anodic gas product streams,¹⁹ and the associated costs render electrocatalytic CO₂ conversion processes unviable. Going beyond this conversion limit is a critical challenge for the field.¹⁸

More particularly, the present technology relates to a multilayer cathode for the electrochemical reduction of CO₂ including a gas diffusion layer, a cathode catalyst layer disposed on the gas diffusion layer, and a permeable CO₂ regeneration layer including an anion exchange ionomer disposed on the cathode catalyst layer.

According to one example, the gas diffusion layer includes a porous material. For example, any known compatible porous material is contemplated. For example, the porous material can be a carbon paper or a porous polymer material. For instance, the porous polymer material can be a fluoropolymer such as PTFE and expanded polytetrafluoroethylene (ePTFE). For example, the gas diffusion layer can be made of a PTFE filter. Alternatively, the gas diffusion layer can be made of a carbon paper substrate with or without a PTFE treatment, preferably with a PTFE treatment. In some examples, the gas diffusion layer has a porosity with pore size in the range of from about 0.01 μm to 2 μm, limits included.

According to another example, the cathode catalyst layer includes a cathode catalyst material that promotes the electrochemical reduction of CO₂. Any compatible cathode catalyst material that promotes the electrochemical reduction of CO₂ is contemplated. Non-limiting examples of cathode catalyst materials include silver, copper, gold, nickel, tin, gallium, zinc, palladium, cadmium, indium, platinum, mercury, thallium, lead, bismuth, cobalt and an alloy including at least one thereof. In one variant of interest, the cathode catalyst material is copper or silver, and preferably copper. In some examples, the cathode catalyst layer has a thickness in the range of from about 50 nm to about 500 nm, limits included.

According to another example, the permeable CO₂ regeneration layer can be designed to provide a substantially alkaline environment at the surface of a cathode catalyst or to enable local CO₂ regeneration to the cathode catalyst. For instance, the permeable CO₂ regeneration layer can be designed to simultaneously impede proton transport and to substantially facilitate the local regeneration of CO₂. In some examples, the material properties of the permeable CO₂ regeneration layer can be as indicated in Table 1 below.

TABLE 1
Material properties of the permeable CO₂ regeneration
layer according to some examples

| | |
|---|---|
| Thickness (μm) | 0.1-10 |
| Ion exchange capacity (Meq/g) | 0.5-3 |
| Permselectivity (%) | 85-100 |
| Water uptake (%) | 10-50 |
| Conductivity (mS/cm) | 2-100 |

According to another example, the anion exchange ionomer of the permeable CO₂ regeneration layer can be selected for its high ionic conductivity or selectivity, high performances (for example, high current density and low voltages), high ion-exchange capacity, high operational efficiency and/or high stability in alkaline conditions. The anion exchange ionomer of the permeable CO₂ regeneration layer can be substantially chemically and oxidatively stable across a substantially broad range of operating conditions. For instance, the anion exchange ionomer of the permeable CO₂ regeneration layer can show essentially zero degradation when subjected to operating conditions such as strong alkaline conditions that would readily degrade other polymers. Any compatible anion exchange ionomer that can shield the surface of the cathode catalyst from protons and/or provide a pathway for regenerated gaseous CO₂ to the cathode catalyst is contemplated. For example, the anion exchange ionomer of the permeable CO₂ regeneration layer can be in solution, in dispersion, or resin form.

According to another example, the anion exchange ionomers can include at least one positively charged functional group directly on the backbone chain of a polymer and/or on a side chain of the polymer. For example, these positively charged functional groups are able to transport anions and block the transport of cations.

Non-limiting examples of anion exchange ionomers include commercial Fumion™ anion ionomer solutions (Fumion™ FAA-3-SOLUT-10, Fuel Cell Store), Sustainion™ alkaline ionomers (XA-9, XB-7, XC-1 and XC-2 series, Fuel Cell Store), Orion TM1 Durion™ polymers (low or medium molecular weight anion exchange resins, Fuel Cell Store), Pention™ dispersions (D72, D35 and D18 series, Fuel Cell Store), PiperION anion exchange dispersions or resin materials (Fuel Cell Store), Durion™ G2 (second generation) dispersions (Fuel Cell Store), Pention™ dispersions (OER and HER series, Fuel Cell Store), Dappion™ Gen1 dispersions (Fuel Cell Store), Aemion™ or Aemion⁺™ membranes or ionomers (Ionomr Innovations inc.). In one variant of interest, the anion exchange ionomer is a commercial Aemion™ AP1-CNN5-00-X ionomer.

According to another example, the multilayer cathode further includes a current collector adjacent to the gas diffusion layer. Any compatible current collector is contemplated.

The present technology also relates to a method of manufacturing a multilayer cathode for the electrochemical reduction of CO₂ as herein defined, the method including the steps of:
depositing a cathode catalyst material onto one side of a gas diffusion layer to provide a cathode catalyst layer thereon; and
coating an anion exchange ionomer solution onto the cathode catalyst layer to provide a permeable CO₂ regeneration layer;
   wherein the cathode catalyst material, the cathode catalyst layer, the gas diffusion layer, the anion exchange ionomer and the permeable CO₂ regeneration layer are as defined above.

According to one example, the step of depositing the cathode catalyst material onto the gas diffusion layer can be performed by a physical vapor deposition method, for example, by sputter deposition.

According to another example, the anion exchange ionomer solution can include from about 0.34 wt. % to about 0.68 wt. % of the anion exchange ionomer, limits included.

According to another example, the anion exchange ionomer solution can be obtained by dissolving an anion exchange ionomer powder in an alcohol. For example, the anion exchange ionomer powder can be dissolved in alcohol (for example, methanol) by sonication.

According to another example, the step of coating the anion exchange ionomer solution onto the cathode catalyst layer can be performed by a spray deposition method. For example, the spray deposition method can be carried out a spraying rate in the range of from about 0.4 mL/h/cm² to about 1.6 mL/h/cm², limits included.

According to another example, the method can further include affixing the other side of the gas diffusion layer on a current collector as defined above.

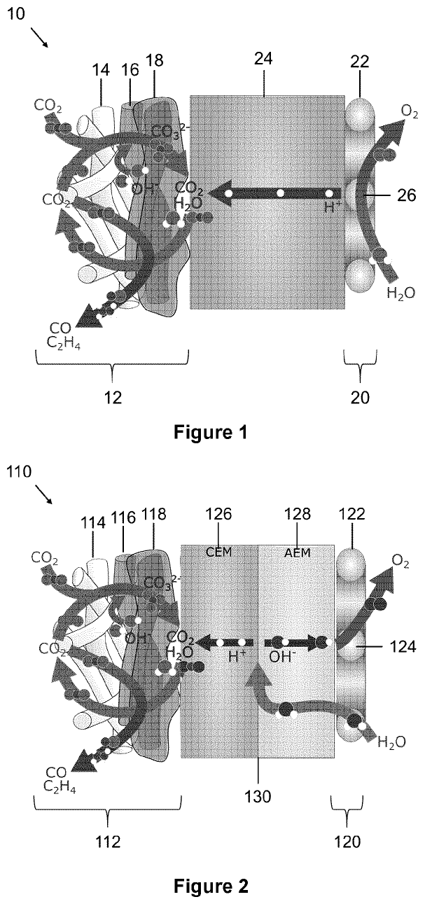

The present technology also relates to a MEA for the electrochemical reduction of CO₂ including a multilayer cathode as defined herein or manufactured by the method as defined herein. For a more detailed understanding of the disclosure, reference is first made to FIG. 1, which provides a schematic representation of a MEA system 10 in accordance with a possible embodiment.

As illustrated in FIG. 1, the MEA system 10 includes a multilayer cathode 12 including a gas diffusion layer 14, a cathode catalyst layer 16 disposed on the gas diffusion layer 14, and a permeable CO₂ regeneration layer 18 including an anion exchange ionomer disposed on the cathode catalyst layer 16. It is to be understood that, the gas diffusion layer 14, the cathode catalyst layer 16, the permeable CO₂ regeneration layer 18 and the anion exchange ionomer are as defined above.

Still referring to FIG. 1, the MEA system 10 also includes an anode 20 including an anode catalyst layer 22 and at least one layer of a CEM 24 disposed between the permeable CO₂ regeneration layer 18 and the anode catalyst layer 22.

According to one example, the multilayer cathode 12 can further include a current collector as defined above (not shown in FIG. 1) adjacent to the gas diffusion layer 14.

As illustrated in FIG. 1, the anode catalyst layer 22 includes an anode catalyst material 26 that promotes electrochemical oxidation of water. Any compatible anode catalyst material that promotes electrochemical oxidation of water is contemplated. The anode catalyst material 26 can include a metal selected from the group consisting of iridium, nickel, iron, cobalt, ruthenium, platinum and an alloy comprising at least one thereof. For example, the anode catalyst material 26 can be a metal oxide, where the metal is as described herein. Non-limiting examples of cathode catalyst materials 26 include iridium oxide, nickel oxide, iron oxide, cobalt oxide, nickel-iron oxide, iridium-ruthenium oxide and platinum oxide. In one variant of interest, the cathode catalyst material 26 is iridium dioxide or an iron-nickel-based catalyst.

According to another example, the anode 20 can further include a current collector (not shown in FIG. 1) adjacent to the anode catalyst layer 22. Any compatible current collector is contemplated.

According to another example, the CEM 24 can be used to separate the anode 20 and multilayer cathode 12 of the MEA system 10. Illustratively, the at least one layer of a CEM 24 is in contact with the permeable CO₂ regeneration layer 18 of the multilayer cathode 12 and the anode catalyst layer 22 of the anode 20. For example, the CEM 24 can be used as a separator and as a solid electrolyte to selectively transport protons across the MEA system 10. Any compatible CEM is contemplated, for example, the CEM 24 can be a perfluorosulfonic acid polymer membrane or a perfluorosulfonic acid-PTFE copolymer membrane. In one variant of interest, the CEM 24 can be a Nafion™ membrane such as a Nafion™ 117 membrane having a thickness of about 183 μm (Fuel Cell Store).

According to another example, the MEA system 10 is a BPMEA system, and further comprises at least one layer of an AEM (not shown in FIG. 1) disposed on the CEM 24 and facing the anode catalyst layer 22 of the anode 20.

The present technology also relates to a BPMEA for the electrochemical reduction of CO₂ including a multilayer cathode as defined herein or manufactured by the method as defined herein. For a more detailed understanding of the disclosure, reference is first made to FIG. 2, which provides a schematic representation of a BPMEA system 110 in accordance with a possible embodiment.

As illustrated in FIG. 2, the BPMEA system 110 includes a multilayer cathode 112 including a gas diffusion layer 114, a cathode catalyst layer 116 disposed on the gas diffusion layer 114, and a permeable CO₂ regeneration layer 118 including an anion exchange ionomer disposed on the cathode catalyst layer 116. It is to be noted that, the gas diffusion layer 114, the cathode catalyst layer 116, the permeable CO₂ regeneration layer 118 and the anion exchange ionomer are as defined above.

Still referring to FIG. 2, the MEA BPMEA system 110 also includes an anode 120 including an anode catalyst layer 122 including an anode catalyst material 124, the MEA BPMEA system 110 also includes at least one layer of a CEM 126 and at least one layer of an AEM 128 disposed between the permeable CO₂ regeneration layer 118 and the anode catalyst layer 122, wherein said at least one layer of a CEM 126 faces the permeable CO₂ regeneration layer 118 and said at least one layer of an AEM 128 faces the anode catalyst layer 122. It is to be noted that, the anode 120, the anode catalyst layer 122 and the anode catalyst material 124 are as defined above.

According to one example, the CEM 126 and the AEM 128 are provided separately. In which case the CEM 126 can be as defined above and any compatible AEM 128 is contemplated. Alternatively, the CEM 126 and the AEM 128 can be provided as a bipolar composite exchange membrane (i.e., as a single film) consisting of an anion exchange layer and a cation exchange layer. Any compatible bipolar composite exchange membrane is contemplated. In one variant of interest, the bipolar composite exchange membrane is a Fumasep™ FBM bipolar membrane (Fuel Cell Store).

Illustratively, the water is dissociated into OH⁻ and H⁺ ions in an intermediate layer 130 (or at the interface 130) between the CEM 126 and the AEM 128. As illustrated in FIG. 2, the BPMEA system 110 can have a reverse biased mode of operation in order to promote the water dissociation reaction. Without wishing to be bound by theory, under the reverse biased operational mode, electrons are transferred from the anode 120 to the multilayer cathode 112. Water molecules readily diffuse into the intermediate layer 130 between the CEM 126 and the AEM 128 and the formation of OH⁻ and H⁺ ions occurs as a result of the water dissociation reaction. H⁺ ions diffuse out from the CEM 126 and migrate into the multilayer cathode 112. Contrarily, OH⁻ ions migrate the anode 120 via the AEM 128 where, under the operating conditions, the oxygen evolution reaction (Equation 5) occurs.

$$20 {H}^{-} \to {H}_{2} O + \frac{1}{2} {O}_{2} + 2 {e}^{-} \qquad ( eq . 5 )$$

According to one example, the multilayer cathode 112 and the anode 120 can further include a current collector as defined above (not shown in FIG. 2) respectively adjacent to the anode catalyst layer 122 and the gas diffusion layer 114.

The present technology also relates to a method of manufacturing a MEA for the electrochemical reduction of CO₂ as herein defined, the method including the steps of:
depositing a cathode catalyst material onto one side of a gas diffusion layer to provide a cathode catalyst layer thereon;
coating an anion exchange ionomer solution onto the cathode catalyst layer to provide a permeable CO₂ regeneration layer;
placing at least one layer of a CEM onto the permeable CO₂ regeneration layer; and
placing an anode comprising on one side an anode catalyst material onto the at least one layer of a CEM, said anode catalyst material facing the at least one layer of a CEM;
   wherein the cathode catalyst material, the cathode catalyst layer, the gas diffusion layer, the anion exchange ionomer, the permeable CO₂ regeneration layer, the CEM, the anode and the anode catalyst material are as defined above.

The present technology also relates to a method of manufacturing a BPMEA for the electrochemical reduction of CO₂ as herein defined, the method including the steps of:
depositing a cathode catalyst material onto one side of a gas diffusion layer to provide a cathode catalyst layer thereon;
coating an anion exchange ionomer solution onto the cathode catalyst layer to provide a permeable CO₂ regeneration layer;
placing at least one layer of a CEM onto the permeable CO₂ regeneration layer;
placing at least one layer of an AEM onto the at least one layer of a CEM; and
placing an anode comprising on one side an anode catalyst material onto the at least one layer of an AEM, said anode catalyst material facing the at least one layer of an AEM;
   wherein the cathode catalyst material, the cathode catalyst layer, the gas diffusion layer, the anion exchange ionomer, the permeable CO₂ regeneration layer, the CEM, the AEM, the anode and the anode catalyst material are as defined above.

According to one example, the step of depositing the cathode catalyst material onto the gas diffusion layer can be performed by a physical vapor deposition method, for example, by sputter deposition.

According to another example, the anion exchange ionomer solution can include from about 0.34 wt. % to about 0.68 wt. % of the anion exchange ionomer, limits included.

According to another example, the anion exchange ionomer solution can be obtained by dissolving an anion exchange ionomer powder in an alcohol. For example, the anion exchange ionomer powder can be dissolved in alcohol (for example, methanol) by sonication.

According to another example, the step of coating the anion exchange ionomer solution onto the cathode catalyst layer can be performed by a spray deposition method. For example, the spray deposition method can be carried out a spraying rate in the range of from about 0.4 mL/h/cm² to about 1.6 mL/h/cm², limits included.

According to another example, the method can further include affixing the other side of the gas diffusion layer on a current collector as defined above.

According to another example, the method can further include affixing the other side of the anode on a current collector as defined above.

The present technology also relates to a use of the multilayer cathode, the MEA or the BPMEA as defined herein or produced by the method as defined herein, for the production of a multicarbon product.

According to another example, the multicarbon product can be any suitable multicarbon products, for example, the multicarbon product can be ethylene or ethanol.

The present technology also relates to a method for electrochemical production of a multicarbon product using the MEA or the BPMEA as defined herein, the method comprising the steps of:
contacting carbon dioxide and an electrolyte with the multilayer cathode, such that the carbon dioxide diffuses through the gas diffusion layer and contacts the cathode catalyst layer;
applying a voltage to provide a current density to cause the carbon dioxide contacting the cathode catalyst layer to be electrochemically reduced into the multicarbon product; and
recovering the multicarbon product.

According to one example, carbonate ions are produced when applying the voltage.

According to another example, carbon dioxide is regenerated from the carbonate ions in the permeable carbon dioxide regeneration layer.

According to another example, the regenerated carbon dioxide is transported to the cathode catalyst layer to be electrochemically reduced into the multicarbon product prior to the recovering step.

According to another example, the multicarbon product is ethylene or ethanol.

The technology described herein can be applied to a wide variety of CO₂ gas streams such as, for example, flue gas and air.

In some cases, where the multilayer cathode as defined herein including the permeable CO₂ regeneration layer is coupled with a CEM cell, it can provide a multicarbon product distribution similar to one obtained with conventional AEM cells. That is, the permeable CO₂ regeneration layer coupled CEM cells can reach about 40% faradaic efficiency towards C₂H₄ and about 55% faradaic efficiency towards multicarbon products. However, using the permeable CO₂ regeneration layer, CO₂ crossover is limited to 15% of the amount of CO₂ converted into products, in all cases. Substantially low crossover and low flow rates combine to enable a single pass CO₂ conversion of 85%±5% (at 100 mA/cm²), with a multicarbon products faradaic efficiency and full-cell voltage comparable to the anion-conducting membrane electrode assembly.

According to some example, the multilayer cathode as defined herein can be designed to block the transport of protons while providing a pathway for regenerated water and gaseous CO₂. This can be achieved via the permeable CO₂ regeneration layer which acts as a permeable anion-selective CO₂ regeneration layer that provides an alkaline condition at the surface of the cathode catalyst layer, amid acidic conditions are provided by the CEM. In this configuration the CO₂-crossover blocking capability of a BPM is substantially retained, with the distinction that evolved CO₂ remains substantially available for reaction. Reactant CO₂ lost to bicarbonate and carbonate can be regenerated locally, and the permeability of the layer allows for the transport of regenerated CO₂ to the cathode catalyst layer for subsequent reactions (FIG. 1).

### EXAMPLES

The following non-limiting examples are illustrative embodiments and should not be construed as limiting the scope of the present invention. These examples will be better understood with reference to the accompanying Figures.

### Example 1: Electrodes Preparation and MEA Configurations

### (a) AEM Cell (for Comparative Purposes)

A conventional AEM cell was assembled for comparative purposes. The cathode was prepared by sputtering 250 nm of copper (99.99%) onto a porous PTFE filter. A stabilizing carbon layer and a conductive graphite layer were then applied on the cathode.^{8,13} The anode was prepared by etching a titanium mesh (0.002″ thickness), or titanium felt (0.3 mm thickness) with boiling 0.5 M oxalic acid for about 10 minutes. The etched titanium mesh or felt was then dip coated in an IrCl₃·x H₂O (30 mg) in isopropanol (10 mL) solution and then calcinated at a temperature of about 500° C. for about 10 minutes. This dip coating process was repeated until a loading of about 1 mg/cm² was obtained.^{8,20,21} The AEM cell was assembled by placing an AEM (Sustainion™ X37-50) between the cathode and the anode described in the present example.

### (b) CEM Cell (for Comparative Purposes)

A conventional CEM cell was assembled for comparative purposes. The cathode was prepared by sputtering 250 nm of copper (99.99%) onto a porous PTFE filter. The anode was prepared by etching a titanium mesh (0.002″ thickness), or titanium felt (0.3 mm thickness) with boiling 0.5 M oxalic acid for about 10 minutes. The etched titanium mesh or felt was then dip coated in an IrCl₃·x H₂O (30 mg) in isopropanol (10 mL) solution and then calcinated at a temperature of about 500° C. for about 10 minutes. This dip coating process was repeated until a loading of about 1 mg/cm² was obtained.^{8,20,21} The CEM cell was assembled by placing a CEM (Nafion™ 117) between the cathode and the anode described in the present example.

### (c) BPMEA Cell (for Comparative Purposes)

A conventional BPM cell was assembled for comparative purposes. The cathode was prepared by sputtering 200 nm of copper (99.99%) onto a PTFE filter. The anode was prepared by etching a titanium mesh (0.002″ thickness), or titanium felt (0.3 mm thickness) with boiling 0.5 M oxalic acid for about 10 minutes. The etched titanium mesh or felt was then dip coated in an IrCl₃·x H₂O (30 mg) in isopropanol (10 mL) solution and then calcinated at a temperature of about 500° C. for about 10 minutes. This dip coating process was repeated until a loading of about 1 mg/cm² was obtained.^{8,20,21} The BPM cell was assembled by placing a BPM (Fumasep™ FBM) between the cathode and the anode described in the present example.

### (d) Permeable CO₂ Regeneration Layer Cell (PCRL-Coupled CEM Cell)

A MEA cell comprising the permeable CO₂ regeneration layer of the present application and a CEM was assembled (PCRL-coupled CEM cell). The cathode was prepared by sputtering 200 nm of copper (99.99%) onto a PTFE filter. The cathode was then sprayed with a dilute anion exchange ionomer solution to achieve the desired loading. The anion exchange ionomer solution was prepared by adding 175 mg of ionomer powder (Aemion™ AP1-CNN5-00-X, Ionomr) to 25 g of methanol and sonicating until fully dissolved. The anode was prepared by etching a titanium mesh (0.002″ thickness), or titanium felt (0.3 mm thickness) with boiling 0.5 M oxalic acid for about 10 minutes. The etched titanium mesh or felt was then dip coated in an IrCl₃·x H₂O (30 mg) in isopropanol (10 mL) solution and then calcinated at a temperature of about 500° C. for about 10 minutes. This dip coating process was repeated until a loading of about 1 mg/cm² was obtained.^{8,20,21} The PCRL-coupled CEM cell was assembled by placing a CEM (Nafion™ 117) between the cathode and the anode described in the present example.

### Example 2: Electrochemical Measurements

The CO₂RR experiments were performed in a 5 cm² cell with 316L stainless steel cathode flow field and a grade 2 titanium anode with matching serpentine flow fields. Throughout all experiments, unless otherwise specified, CO₂ was flowed at 80 sccm using a mass flow controller, while the anode side was fed with 100 mM KHCO₃ with the AEM and deionised (DI) water with the CEM, BPM and PCRL-coupled CEM cells at 10 mL/min with a peristaltic pump. The electrochemical measurements were performed with a potentiostat (Autolab PGSTAT204 equipped with 10 A booster). The cell voltages are reported in all figures without iR correction (or iR compensation).

### Example 3: Product Analysis

The CO₂RR gas products, oxygen and CO₂ were analyzed by sampling the gas outlet stream with a gas chromatograph (Perkin Elmer Clarus™ 590) coupled with a thermal conductivity detector (TCD) and flame ionization detector (FID). The gas chromatograph was equipped with a Molecular Sieve 5 A Capillary Column and a packed Carboxen-1000 Column with argon as the carrier gas. The volumetric gas flow rates in and out of the cells were measured with a bubble column.

The liquid products were quantified by proton nuclear magnetic resonance (¹H NMR) spectroscopy using an Agilent DD2 500 MHz NMR Spectrometer in deuterium oxide (D₂O) using water suppression mode, with dimethyl sulfoxide (DMSO) as the internal standard.

### Example 4: Electrode Characterization

The copper catalyst and the permeable CO₂ regeneration layer were characterized by scanning electron microscopy (SEM) using a FEI Quanta™ FEG 250 environmental SEM at low vacuum or under ESEM mode. The optical microscope images were taken using a LEICA DMC 2900 microscope with a 10× magnification objective.

### Example 5: One-Dimensional Modeling

A one-dimensional system was modeled using COMSOL Multiphysics™ version 5.5, building upon the previous modeling works.²²⁻²⁷ The pH and species concentrations of different PCRL coating thicknesses (2 μm, 5 μm, and 10 μm) were compared. The detailed simulation consisted of a copper cathode catalyst, a permeable CO₂ regeneration layer, a CEM, and an iridium anode catalyst. The secondary current distribution and transport of diluted species physics modules were applied for the numerical models. The simulation assumed a constant concentration supply of CO₂ at the left boundary of the cathode catalyst layer and constant species concentrations at the right boundary of the anode layer.

The CO₂ solubility was calculated based on Henry's Law and sets of Sechenov Equations.²⁷ The temperature and pressure affect CO₂ solubility. The corresponding Sechenov constants are listed in Table 2 below.²⁸

TABLE 2
Sechenov constants

| Species | hᵢₒₙ |
|---|---|
| OH⁻ | 0.0839 |
| HCO₃⁻ | 0.1423 |
| CO₃²⁻ | 0.0967 |
| h_{G, 0, CO}_{₂} | −0.0172 |
| h_{T, CO}_{₂} | −0.000338 |

Diffusion and electromigration were considered for all species, and they are governed by the Nernst-Planck set of equations. The porosity coefficient was of 0.9, 0.1 for the permeable CO₂ regeneration layer and the CEM layer, respectively. The transportation of species was calculated in the same manner as the previous work.²⁷ The corresponding diffusion coefficients and charge numbers are listed in Table 3 below.²⁹⁻³¹

TABLE 3
Diffusion coefficients and charge numbers

| Species | Dᵢ(m²s⁻¹) | zᵢ (−) |
|---|---|---|
| H⁺ | 9.31e−9 | +1 |
| OH⁻ | 5.26e−9 | −1 |
| HCO₃⁻ | 1.185e−9 | −1 |
| CO₃²⁻ | 0.923e−9 | −2 |
| CO₂ (aq) | 1.91e−9 | 0 |
| H₂O | 2.57e−9 | 0 |

Ohm's Law was applied to determine the electrode and electrolyte potentials, and the Poisson Equations were considered for the electromigration of the charged species (H⁺, OH⁻, HCO₃⁻, CO₃²⁻). The electromigration effect was calculated in the same manner as the previous work.²⁷ The corresponding electrical conductivities of different layers are listed in Table 4 below.³²⁻³³

TABLE 4
Diffusion coefficients and charge numbers

| | Electrical / ionic |
|---|---|
| Domain | conductivity [S/m] |
| Permeable CO₂ regeneration layer | 8.0 |
| CEM | 24.92 |

Five electrochemical catalyst reactions were considered in this simulation. More particularly, the CO₂RR produces H₂, CO, C₂H₄, and C₂H₅OH at the cathode catalyst layer. The oxygen evolution reaction occurs at the anode catalyst layer. The electrochemical reactions were calculated in the same manner as the previous work.²⁷ The corresponding CO₂ reduction reactions and oxygen evolution reaction are listed in Tables 5 and 6 below.

TABLE 5
CO₂RR

2H₂O + 2e⁻ → H₂ + 2OH⁻
CO₂ + H₂O + 2e⁻ → CO + 2OH⁻
2CO₂ + 8H₂O + 12e⁻ → C₂H₄ + 12OH⁻
2CO₂ + 9H₂O + 12e⁻ → C₂H₅OH + 12OH⁻

TABLE 6
Oxygen evolution reaction

2H₂O → O₂ + 4H⁺ + 2e⁻

The steady-state equilibrium between H⁺, OH⁻, HCO₃⁻, CO₃²⁻, and CO₂ were determined by the sets of carbonate equilibrium equations. Water dissociation was also considered in this simulation. The carbonate equilibrium equations were calculated in the same manner as the previous work.²⁷ The corresponding carbonate equilibrium equations and water dissociation equation are listed in Tables 7 and 8 below.

TABLE 7
Carbonate equilibrium equations

CO₂ + H₂O ↔ H⁺ + HCO₃⁻
HCO₃ ↔ H⁺ + CO₃²⁻
CO₂ + OH⁻ ↔ HCO₃⁻
HCO₃⁻ + OH⁻ ↔ CO₃²⁻ + H₂O

TABLE 8
Water dissociation equation

H₂O ↔ H⁺ + OH⁻

### Example 6: Results and Discussion

### (a) Electrochemical Performances in an AEM Cell (for Comparative Purposes)

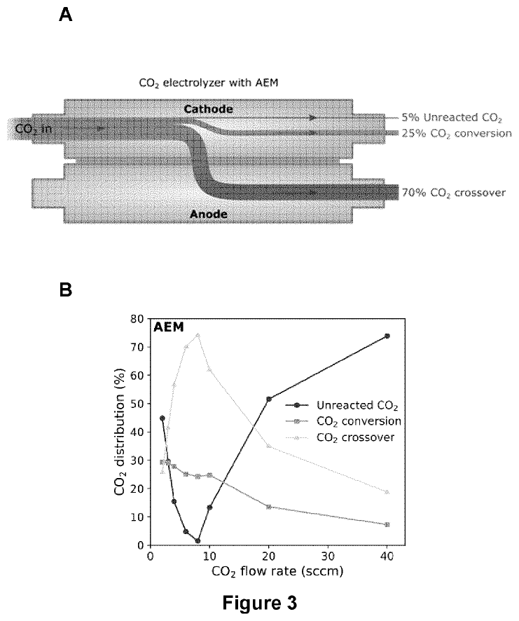

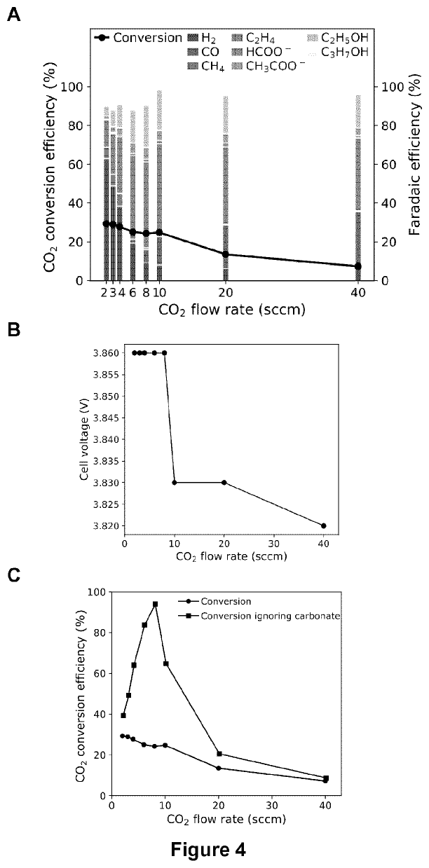

FIG. 3 shows CO₂ reactant loss in the conventional MEA with an AEM prepared in Example 1(a). As illustrated in FIG. 3A, the AEM cell while operating at 150 mA/cm² and a CO₂ flow rate of 6 sccm the distribution of CO₂ obtained was 5% of unreacted CO₂, 25% of utilized CO₂ and 70% of crossover of CO₂ and liquid products from the cathode to the anode. FIG. 3B shows a graph of the composition of the cathode and anode gas and liquid products or CO₂ distribution as a function of the CO₂ flow rate obtained for the AEM cell operating at 150 mA/cm² while the flow rate of the CO₂ fed into the cell was varied. At flow rates of 20 and 40 sccm, there was sufficient mass transport of CO₂ to the catalyst, evidenced by the low 7% H₂ faradaic efficiency (FIGS. 4A and 4B). However, the total amount of input CO₂ converted to products was less than 15%. At flow rates between 6 sccm and 10 sccm, CO₂ mass transport became limiting and the hydrogen evolution reaction increased from 8% faradaic efficiency at 10 sccm to 20% faradaic efficiency at 6 sccm. The unreacted CO₂ in the outlet stream reached a minimum value of 1% that of inlet CO₂ (8 sccm). The CO₂ conversion reached its maximum between 25 and 30% (exceeding the established conversion limit for multicarbon production due to a small amount of C₁ production).

The CO₂ transported through the membrane matched that predicted for the case of carbonate as the sole charge carrier. The resulting anode head gas contained a mixture of 60-70 vol. % CO₂ and 30-40 vol. % O₂. Regenerating a reactable CO₂ stream from this mixture would require an energy-intensive chemical absorption separation process (e.g. monoethanolamine CO₂ absorption).³⁴

The CO₂ conversion efficiency (%) with no carbonate formation in the MEA with an AEM was also calculated. FIG. 4C shows the conversion efficiency when carbonate formation was subtracted in the MEA with an AEM at 150 mA/cm² at varying CO₂ flow rate. The anode gas flow rate and composition were measured to determine the amount of CO₂ that was transported through the membrane via carbonate. The conversion with no carbonate increased as the CO₂ flow rate was decreased from 40 sccm to 8 sccm because there was a smaller quantity of unreacted CO₂. As the CO₂ flow rate was decreased from 8 sccm to 2 sccm, the CO₂ mass transport to the catalyst was insufficient and the amount of CO₂ that left the cell unreacted increased. Of the CO₂ that did not react to form carbonate, 94% could be reacted to form products at 8 sccm.

### (b) Electrochemical Performances in a CEM Cell (for Comparative Purposes)

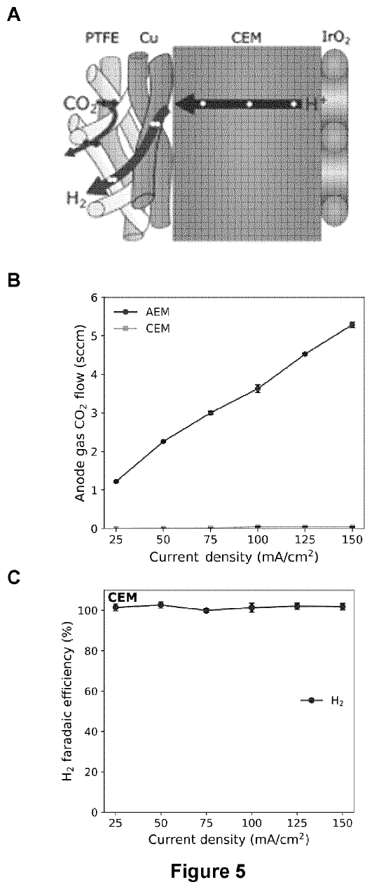

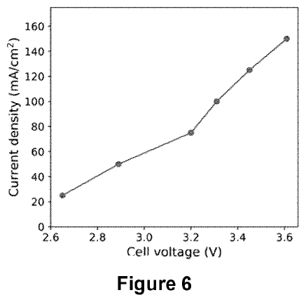

FIG. 5 shows the CO₂RR electrochemical performance using the conventional MEA with a CEM prepared in Example 1 (b). FIG. 5A shows a schematic representation of species transport within the MEA with a CEM. As can be observed, incorporating a CEM in place of the AEM blocks carbonate transport to the anode.³⁵ The CO₂RR performance was measured. Deionized water was employed as the anolyte to ensure that protons were the sole charge carrier. The loss of CO₂ was avoided at all current density (FIG. 5B), but the cathode environment was too acidic for efficient CO₂RR at current density greater than 25 mA/cm² (i.e., no CO₂RR products were detected) (FIG. 5C).³⁶⁻⁴⁰ The acidic cathode environment can improve hydrogen evolution reaction kinetics and can deteriorate CO₂RR kinetics (FIG. 6); therefore, hydrogen evolution reaction dominates in the CEM configuration.

### (c) Electrochemical Performances in a BPM Cell (for Comparative Purposes)

Pairing anion and cation selective membrane layers in a BPM is another approach to block reactant and product crossover in electrolyzers.^{16,35} With the CEM adjacent to the cathode (in a conventional reverse-bias BPM configuration) the cathode becomes acidic due to the influx of protons and, as in the CEM electrolyzer, is not productive in the CO₂RR without an additional buffer layer.⁴¹⁻⁴² An alkaline environment at the cathode can be achieved in a conventional forward-bias BPM configuration, with the AEM layer adjacent to the cathode.

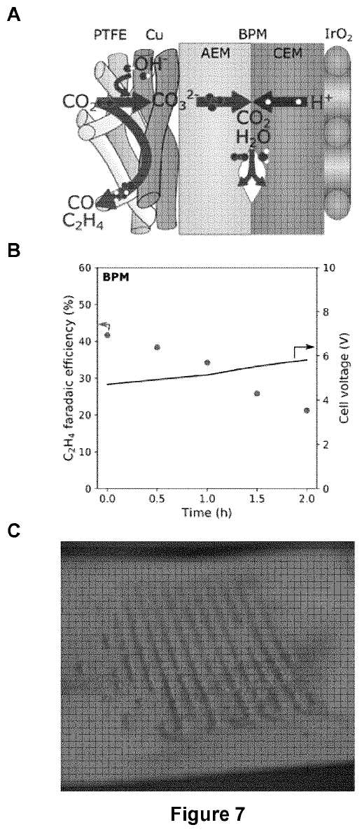

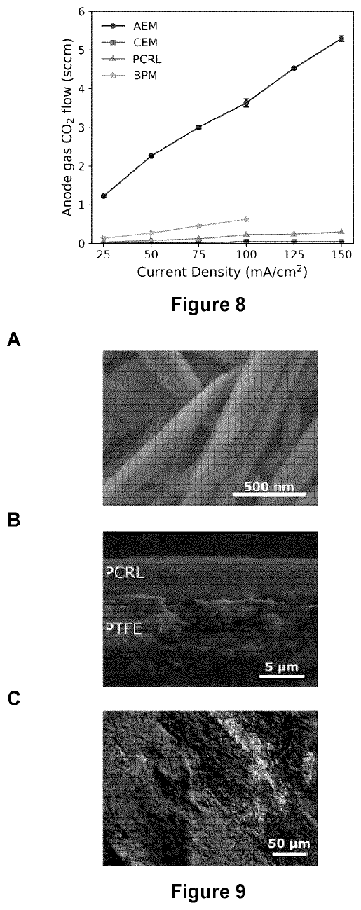

FIG. 7 shows the CO₂RR electrochemical performance using the conventional MEA with a BPM prepared in Example 1 (c) in the forward bias at a low current density (50 mA/cm²). FIG. 7A shows a schematic representation of species transport within the MEA with a BPM. More CO₂ in the anode gas was observed compared to the CEM cell (FIG. 8) due to the accumulation and pressure build-up of water and gaseous CO₂ at the membrane junction and subsequent migration to both the cathode and anode sides. The formation of the CO₂ and water at the membrane junction caused the AEM and CEM to delaminate (FIG. 7C), and resulted in loss of ethylene faradaic efficiency within 0.5 hours (FIG. 7B).¹⁶ The conventional BPM does not provide a solution to the CO₂ conversion challenge because reactant CO₂ is lost to the membrane junction and the system is unstable even at a low current density (50 mA/cm²).

### (d) Electrode Characterization and Electrochemical Performances in a PCRL-Coupled CEM Cell

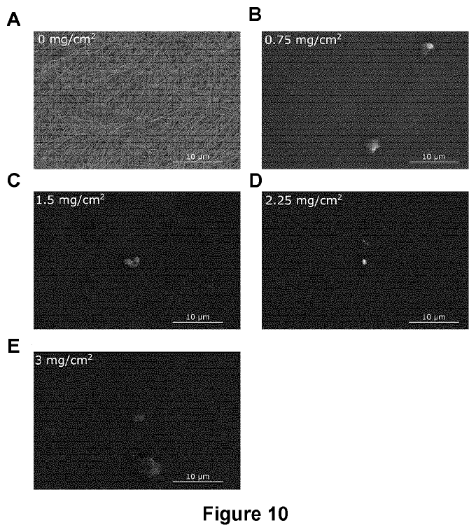

The copper catalyst and permeable CO₂ regeneration layer of the cathode prepared in Example 1(d) were characterized by SEM. As described in Example 1(d), the cathode was prepared by first sputtering copper on a porous PTFE filter (FIG. 9A), then a PCRL coating was deposited onto the copper layer (FIGS. 9B and 9C). FIGS. 10A to 10E show SEM images obtained for cathodes with different PCRL loadings. It is to be noted that since the PCRL is not electrically conductive, any exposed copper catalyst would be bright in comparison. As can be seen in FIGS. 10B to 10E, the PCRL coatings appear to be substantially uniform.

Without wishing to be bound by theory, the functional groups of the anion exchange polymer (Aemion™ AP1-CNN5-00-X) can create a positive space charge, enabling the transport of anions and impeding the transport of cations. The polymer coating on the cathode can allow for CO₂ transport to the catalyst via diffusion through the water-filled hydrated ionic domains in the polymer matrix.^{43,44} For example, the PCRL coating can be substantially thin, less than about 10 μm (FIG. 9B), to substantially minimize the obstruction of water and CO₂ from the membrane junction to the catalyst surface.⁴⁵

The CO₂RR typically requires the presence of alkali metal cations in the Outer Helmholtz Plane to create a reaction environment suitable for efficient conversion.⁴⁶⁻⁴⁸ However, within the PCRL, the positively charged functional groups can also act as a fixed positive charge near the catalyst surface that can stabilize CO₂RR intermediates to promote C—C coupling on copper catalysts. The quaternary ammonium and heterocyclic (including imidazolium and benzimidazolium) functional groups that are commonly used as the positive charge in anion exchange ionomers⁴³ have been shown to allow for the intermolecular interaction of water with surface adsorbed CO and promote the hydrogenation of surface bound CO to ethylene.⁴⁹⁻⁵⁴ In some example, the cations contained within the polymer structure of the PCRL can eliminate the need for alkali metal cations in the electrolyte.

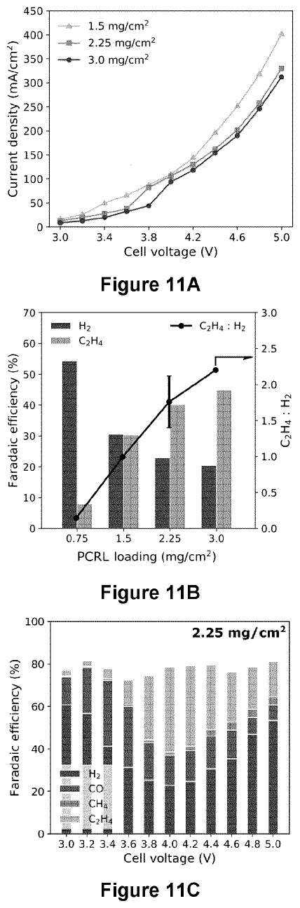

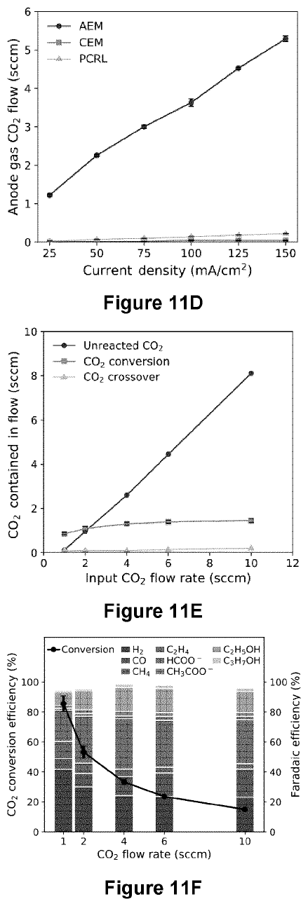

The electrochemical performances in the MEA cell with a Nafion™ 117 CEM, an IrO₂ anode, and DI water anolyte prepared in Example 1(d) were evaluated (FIG. 11) to assess the impact of the PCRL on the cathode pH and CO₂ conversion efficiency. The Nafion™ 117 CEM was selected to provide a substantially greater thickness compared to more commonly applied Nafion™ XL and Nafion™ 211 membranes. For example, a thicker CEM can provide a larger diffusion barrier to minimize transport of CO₂ through the hydrophobic domains of the Nafion™ polymer.^{55,56} The use of DI water anolyte can ensure that protons are the only cations that can transport charge through the CEM. If any salts were to be present in the anolyte, the associated cations would be transported through the CEM and react with carbonate and bicarbonate to form salts at the junction of the PCRL and CEM, thus preventing CO₂ from being regenerated and recycled to the cathode catalyst. Cathodes with PCRL coatings of different loadings were prepared and their performances were assessed in an electrolyzer in terms of current, faradaic efficiency, CO₂ crossover and overall CO₂ conversion efficiency.

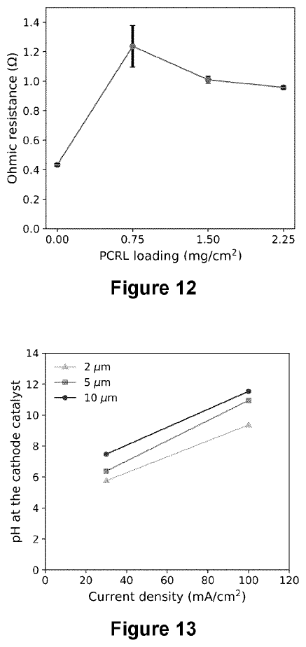

The current-voltage response with loadings of PCRL coating between 1.5 mg/cm² and 3 mg/cm² were characterized (FIG. 11A). The voltage was varied from 3 to 5 V and the samples with lower loadings reached higher currents. The observed differences in current density among the samples are not due to changes in the ionic conduction because of the relatively constant ohmic resistance (FIG. 12). FIG. 12 presents ohmic resistance results obtained with a PCRL-coupled CEM. The ohmic resistance was measured using electrochemical impedance spectroscopy (EIS) in a 5 cm² cell. The loading of 0 represents a cell assembled with a cathode, but without the PCRL.

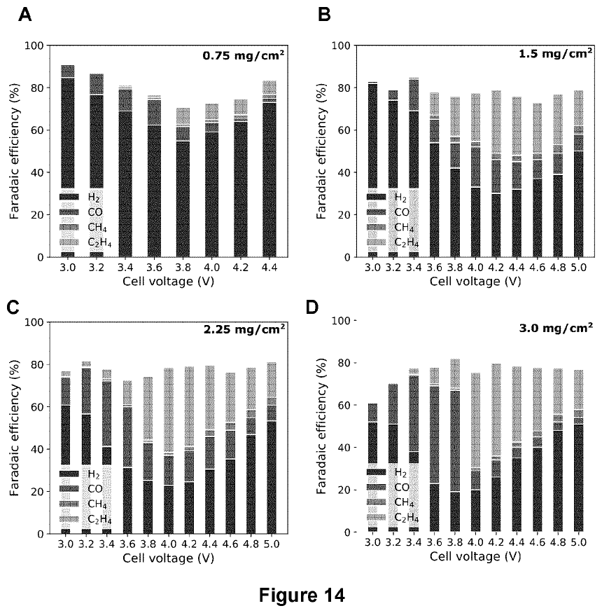

Differences in the thickness of the PCRL coating could not explain the observed changes in current density because of the relatively high ionic conductivity of the PCRL coating (>10 mS/cm). The current response was instead attributed to changes in the local pH at the cathode; a 3 mg/cm² loading provided a higher pH, and thus a larger Nernstian pH voltage loss, compared to a 1.5 mg/cm² loading. Nernstian loss increased cell voltage by 0.059 V per unit difference in pH between the cathode and anode. For each PCRL loading, a substantially large change in current density was observed once about 40 mA/cm² was reached, which can correspond to a change in the reaction mechanism. At current density less than about 40 mA/cm², the potential required for protons to pass through the PCRL and be consumed directly in the CO₂RR and hydrogen evolution reaction was less than the potential required to form alkaline conditions at the cathode. At current density greater than about 40 mA/cm², the PCRL was not adequately conductive for protons to pass through at a sufficient rate, so it became kinetically favourable for water near the catalyst to become the proton donor leading to a further increase in the pH from the produced hydroxide ions. This effect is confirmed by a one-dimensional multiphysics model that estimated the pH at the cathode as a function of the coating thickness and the current density (FIG. 13). This shift was reflected in the current-voltage response (FIG. 11A) and corresponded to a higher cathode pH and an increase in C₂H₄ selectivity (FIG. 14).

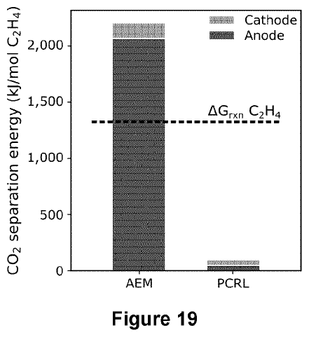

Increasing the PCRL loading from 0.75 mg/cm² to 2.25 mg/cm² caused the hydrogen evolution reaction to decrease from 54% to 23%, faradaic efficiency and the CO₂RR towards C₂H₄ to increase from 8% to 40% faradaic efficiency (FIG. 11B). The increased PCRL thickness can create a substantially more effective proton transport barrier, leading to a higher pH at the cathode. Increasing the PCRL loading to 3.0 mg/cm² did not further increase the faradaic efficiency for H₂ and C₂H₄ compared to the 2.25 mg/cm² layer which suggests that the local pH at the cathode is not the limiting factor beyond a threshold alkaline pH. The 2.25 mg/cm² case exhibited similar currents to the 3 mg/cm² layer while showing similar product selectivity. As the voltage was increased from 3.0 V to 3.6 V, the faradaic efficiency for H₂ decreased and CO became the major product at 28% faradaic efficiency (FIG. 11C). Once the voltage was increased from 3.8 V to 4.2 V, the pH at the cathode became high enough for significant multicarbon production and the maximum C₂H₄ faradaic efficiency of 40% was reached. Increasing the voltage beyond 4.2 V increased the faradaic efficiency for H₂ due to CO₂ mass transport limitations in the PCRL, an effect observed previously for hydrophilic cathode layers.⁵⁵ The 2.25 mg/cm² PCRL loading case provided steady selectivity and cell voltage for 8 hours of continuous operation at 100 mA/cm² (FIG. 17).

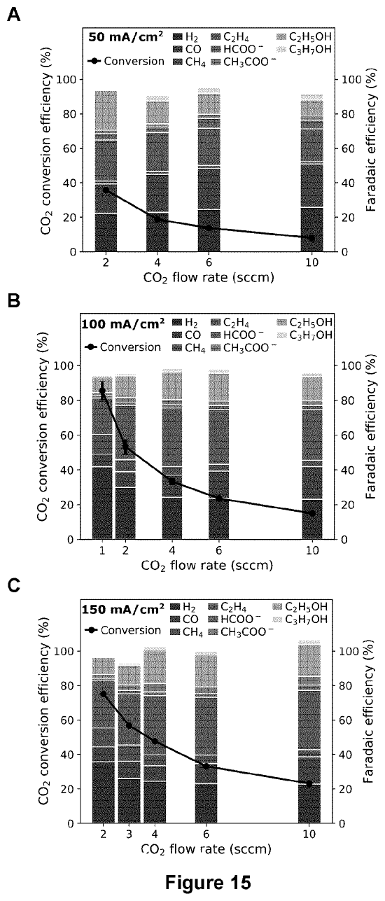

To measure the effectiveness of the PCRL-coupled CEM in preventing CO₂ loss, the concentration and flow rate of CO₂ in the anode gas (FIG. 11D) were measured. With the PCRL layer, CO₂ outflow from the anode gas was less than 4% that of the AEM comparative case (i.e., 0.2 sccm with the PCRL, versus >5 sccm with the AEM at the same reaction rate of 150 mA/cm²). Some CO₂ in the anode gas can be attributed to liquid product crossover and subsequent oxidation (further supported by the 5-10% missing faradaic efficiency (FIG. 15). Depending on the liquid product oxidized to CO₂ (e.g. ethanol vs. formate), this route could account for 30-100% of the 0.2 sccm of CO₂ measured in the anode tail gas. For all input CO₂ flow rates, the amount of CO₂ that crossed over (FIG. 11E) was less than 15% of the amount of CO₂ converted into products (e.g. 0.2 sccm crossover, compared to 1.4 sccm converted). Low crossover enables high CO₂ conversion at flow rates less than 2 sccm. Selectivity was relatively constant at high input CO₂ flow rates (FIG. 11F), but below 4 sccm CO₂ mass transport limitations were reached and the faradaic efficiency for H₂ increased. At 1 sccm, a CO₂ conversion efficiency of 85%±5% was achieved (with a faradaic efficiency of 53% toward CO₂RR products), representing the highest CO₂ conversion efficiency reported in the literature to date, regardless of the targeted product. 57

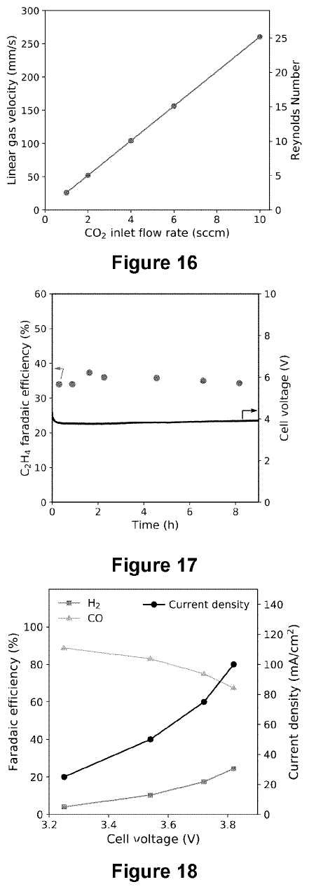

FIG. 16 presents the linear gas velocity and Reynolds Number of the CO₂ flow in the cell. The linear gas velocity and Reynolds number use the average flow velocity in a 0.8 mm by 0.8 mm channel.

To challenge the general applicability of the PCRL strategy this approach was applied with a CO-producing sputtered silver catalyst (FIG. 18). The current densities in the silver catalyst case were lower than those with the copper catalyst because the production of CO requires three times more CO₂ per unit of current. The PCRL strategy resulted in selective production of CO with over 75% faradaic efficiency for all current densities up to 100 mA/cm². This result demonstrates that PCRL-coupled CEM configuration provides a locally alkaline cathodic environment that is applicable to CO₂RR catalysts, generally.

The high CO₂ conversion achieved with the PCRL approach does not come at the cost of other performance metrics. The cell voltage and faradaic efficiency with the PCRL were similar to those achieved with the conventional AEM cell (FIGS. 4A and 4B), and advances in AEMs are applicable to the PCRL. The major sources of voltage loss for both cells are the thermodynamic potential, the catalyst overpotentials, and the Nernstian pH loss.^{8,58} The faradaic efficiency toward C₂H₄ in particular could be improved further by incorporating specialized catalysts, such as polyamine incorporated Cu.⁵⁹⁻⁶¹ The energy efficiency of the PCRL system may also be increased further with advances in the CO₂ permeability of the anion exchange ionomers, an active area of research.⁴⁴

A major benefit of high CO₂ conversion is the avoidance of gas separation costs. After passing through the electrolyzer, any substantial CO₂ content in the anode tail gas must be separated and recirculated, and any unreacted CO₂ in the cathode tail gas must be separated from desired gas products. While membrane-based and pressure-swing separation approaches are emerging for C₂H₄/CO₂ separation,^{62,63} typical CO₂ removal processes currently rely on a chemical absorption unit, such as monoethanolamine absorption.³⁴ In the best-case conversion scenarios achieved here, the molar ratio of output CO₂ to C₂H₄ produced streams was 0.6 in the PCRL case, compared to 12 with the AEM. The 20-fold reduction in CO₂ content of the cell output, most of which was achieved on the anode side, results in dramatic savings in CO₂ separation energy costs (FIG. 19). The energy cost of CO₂ separation from the AEM electrolyzer anode output stream dominates, at 2067 KJ/mol of produced C₂H₄. The energy intensity of this peripheral separation process surpasses the Gibbs free energy of the reaction, rendering the conventional AEM approach untenable. Therefore, the PCRL approach can provide a solution to the CO₂ conversion challenge and a way forward for the electrocatalytic conversion of CO₂.

The following documents and any others mentioned herein are incorporated herein by reference in their entirety.

### REFERENCES

1. Ho, Minh T., Guy W. Allinson, and Dianne E. Wiley. “Reducing the cost of CO₂ capture from flue gases using pressure swing adsorption.” Industrial & Engineering Chemistry Research 47.14 (2008): 4883-4890.
2. Whipple, Devin T., and Paul J A Kenis. “Prospects of CO₂ utilization via direct heterogeneous electrochemical reduction.” The Journal of Physical Chemistry Letters 1.24 (2010): 3451-3458.
3. De Luna, Phil, et al. “What would it take for renewably powered electrosynthesis to displace petrochemical processes?.” Science 364.6438 (2019).
4. Bushuyev, Oleksandr S., et al. “What should we make with CO₂ and how can we make it?.” Joule 2.5 (2018): 825-832.
5. Verma, Sumit, et al. “A gross-margin model for defining technoeconomic benchmarks in the electroreduction of CO₂.” ChemSusChem 9.15 (2016): 1972-1979.
6. Jouny, Matthew, Wesley Luc, and Feng Jiao. “General techno-economic analysis of CO₂ electrolysis systems.” Industrial & Engineering Chemistry Research 57.6 (2018): 2165-2177.
7. Kutz, Robert B., et al. “Sustainion imidazolium-functionalized polymers for carbon dioxide electrolysis.” Energy Technology 5.6 (2017): 929-936.
8. Gabardo, Christine M., et al. “Continuous carbon dioxide electroreduction to concentrated multi-carbon products using a membrane electrode assembly.” Joule 3.11 (2019): 2777-2791.
9. Vennekötter, Jan-Bernd, et al. “The electrolyte matters: Stable systems for high rate electrochemical CO₂ reduction.” Journal of CO₂ Utilization 32 (2019): 202-213.
10. Liang, Shuyu, et al. “Electrolytic cell design for electrochemical CO₂ reduction.” Journal of CO₂ Utilization 35 (2020): 90-105.
11. Weng, Lien-Chun, Alexis T. Bell, and Adam Z. Weber. “Towards membrane-electrode assembly systems for CO₂ reduction: a modeling study.” Energy & Environmental Science 12.6 (2019): 1950-1968.
12. Verma, Sumit, et al. “The effect of electrolyte composition on the electroreduction of CO₂ to CO on Ag based gas diffusion electrodes.” Physical Chemistry Chemical Physics 18.10 (2016): 7075-7084.
13. Dinh, Cao-Thang, et al. “CO₂ electroreduction to ethylene via hydroxide-mediated copper catalysis at an abrupt interface.” Science 360.6390 (2018): 783-787.
14. Xu, Yi, et al. “Self-cleaning CO₂ reduction systems: unsteady electrochemical forcing enables stability.” ACS Energy Letters 6.2 (2021): 809-815.
15. Voice, Alexander K., and Gary T. Rochelle. “Oxidation of amines at absorber conditions for CO₂ capture from flue gas.” Energy Procedia 4 (2011): 171-178.
16. Pǎtru, Alexandra, et al. “Design principles of bipolar electrochemical co-electrolysis cells for efficient reduction of carbon dioxide from gas phase at low temperature.” Journal of The Electrochemical Society 166.2 (2019): F34.
17. Larrazábal, Gastón O., et al. “Analysis of mass flows and membrane cross-over in CO₂ reduction at high current densities in an MEA-type electrolyzer.” ACS applied materials & interfaces 11.44 (2019): 41281-41288.
18. Rabinowitz, Joshua A., and Matthew W. Kanan. “The future of low-temperature carbon dioxide electrolysis depends on solving one basic problem.” Nature Communications 11.1 (2020): 1-3.
19. Greenblatt, Jeffery B., et al. “The technical and energetic challenges of separating (photo) electrochemical carbon dioxide reduction products.” Joule 2.3 (2018): 381-420.
20. Luc, Wesley, Jonathan Rosen, and Feng Jiao. “An Ir-based anode for a practical CO₂ electrolyzer.” Catalysis Today 288 (2017): 79-84.
21. Yeo, R. S., et al. “Ruthenium-Based Mixed Oxides as Electrocatalysts for Oxygen Evolution in Acid Electrolytes.” Journal of the Electrochemical Society 128.9 (1981): 1900.
22. Singh, Meenesh R., et al. “Effects of electrolyte, catalyst, and membrane composition and operating conditions on the performance of solar-driven electrochemical reduction of carbon dioxide.” Physical Chemistry Chemical Physics 17.29 (2015): 18924-18936.
23. Singh, Meenesh R., et al. “Mechanistic insights into electrochemical reduction of CO₂ over Ag using density functional theory and transport models.” Proceedings of the National Academy of Sciences 114.42 (2017): E8812-E8821.
24. Burdyny, Thomas, et al. “Nanomorphology-enhanced gas-evolution intensifies CO₂ reduction electrochemistry.” ACS Sustainable Chemistry & Engineering 5.5 (2017): 4031-4040.
25. Weng, Lien-Chun, et al. “Modeling gas-diffusion electrodes for CO₂ reduction.” Physical Chemistry Chemical Physics 20.25 (2018): 16973-16984.
26. Weng, Lien-Chun, et al. “Towards membrane-electrode assembly systems for CO₂ reduction: a modeling study.” Energy & Environmental Science 12.6 (2019): 1950-1968.
27. Xu, Yi, et al. “Self-cleaning CO₂ reduction systems: unsteady electrochemical forcing enables stability.” ACS Energy Letters 6.2 (2021): 809-815.
28. Weisenberger, S., and dan A. Schumpe. “Estimation of gas solubilities in salt solutions at temperatures from 273 K to 363 K.” AIChE Journal 42.1 (1996): 298-300.
29. Vanysek, Petr. “Ionic conductivity and diffusion at infinite dilution.” CRC Hand Book of Chemistry and Physics 96 (73) (2002): 5-98.
30. Applin, Kenneth R., and Antonio C. Lasaga. “The determination of SO₄²⁻, NaSO₄⁻, and MgSO₄⁰ tracer diffusion coefficients and their application to diagenetic flux calculations.” Geochimica et Cosmochimica Acta 48.10 (1984): 2151-2162.
31. Leaist, Derek G. “Diffusion in aqueous solutions of sulfuric acid.” Canadian journal of chemistry 62.9 (1984): 1692-1697.
32. Gabardo, Christine M., et al. “Continuous carbon dioxide electroreduction to concentrated multi-carbon products using a membrane electrode assembly.” Joule 3.11 (2019): 2777-2791.
33. Napoli, L., et al. “Conductivity of Nafion® 117 membrane used in polymer electrolyte fuel cells.” International journal of hydrogen energy 39.16 (2014): 8656-8660.
34. Aaron, Douglas, and Costas Tsouris. “Separation of CO₂ from flue gas: a review.” Separation science and technology 40.1-3 (2005): 321-348.
35. Ma, Ming, et al. “Role of ion-selective membranes in the carbon balance for CO₂ electroreduction via gas diffusion electrode reactor designs.” Chemical science 11.33 (2020): 8854-8861.
36. Aeshala, L. M., S. U. Rahman, and A. Verma. “Effect of solid polymer electrolyte on electrochemical reduction of CO₂.” Separation and purification technology 94 (2012): 131-137.
37. Dewulf, David W., and Allen J. Bard. “The electrochemical reduction of CO₂ to CH₄ and C₂H₄ at Cu/Nafion electrodes (solid polymer electrolyte structures).” Catalysis letters 1.1 (1988): 73-79.
38. Komatsu, Seiji, et al. “Preparation of cu-solid polymer electrolyte composite electrodes and application to gas-phase electrochemical reduction of CO₂.” Electrochimica acta 40.6 (1995): 745-753.
39. Kim, Byoungsu, et al. “Influence of dilute feed and pH on electrochemical reduction of CO₂ to CO on Ag in a continuous flow electrolyzer.” Electrochimica Acta 166 (2015): 271-276.
40. Newman, John, et al. “Design of an electrochemical cell making syngas (CO+ H-2) from CO₂ and H₂O reduction at room temperature.” Journal of The Electrochemical Society 155.1 (2007): B42-B49.
41. Li, Yuguang C., et al. “Electrolysis of CO₂ to syngas in bipolar membrane-based electrochemical cells.” ACS Energy Letters 1.6 (2016): 1149-1153.
42. Salvatore, Danielle A., et al. “Electrolysis of Gaseous CO₂ to CO in a Flow Cell with a Bipolar Membrane.” ACS Energy Letters 3.1 (2017): 149-154.
43. Varcoe, John R., et al. “Anion-exchange membranes in electrochemical energy systems.” Energy & environmental science 7.10 (2014): 3135-3191.
44. Salvatore, Danielle A., et al. “Designing anion exchange membranes for CO₂ electrolysers.” Nature Energy 6.4 (2021): 339-348.
45. Oener, Sebastian Z., et al. “Thin Cation-Exchange Layers Enable High-Current-Density Bipolar Membrane Electrolyzers via Improved Water Transport.” ACS Energy Letters 6.1 (2020): 1-8.
46. Waegele, Matthias M., et al. “How cations affect the electric double layer and the rates and selectivity of electrocatalytic processes.” The Journal of chemical physics 151.16 (2019): 160902.
47. Murata, Akira, and Yoshio Hori. “Product selectivity affected by cationic species in electrochemical reduction of CO₂ and CO at a Cu electrode.” Bulletin of the Chemical Society of Japan 64.1 (1991): 123-127.
48. Singh, Meenesh R., et al. “Hydrolysis of electrolyte cations enhances the electrochemical reduction of CO₂ over Ag and Cu.” Journal of the American Chemical Society 138.39 (2016): 13006-13012.
49. Li, Jingyi, et al. “Hydrogen bonding steers the product selectivity of electrocatalytic CO reduction.” Proceedings of the National Academy of Sciences 116.19 (2019): 9220-9229.
50. Rosen, Brian A., et al. “Ionic liquid-mediated selective conversion of CO2 to CO at low overpotentials.” Science 334.6056 (2011): 643-644.
51. Asadi, Mohammad, et al. “Nanostructured transition metal dichalcogenide electrocatalysts for CO₂ reduction in ionic liquid.” Science 353.6298 (2016): 467-470.
52. Sun, Liyuan, et al. “Switching the reaction course of electrochemical CO₂ reduction with ionic liquids.” Langmuir 30.21 (2014): 6302-6308.
53. Grills, David C., et al. “Electrocatalytic CO₂ reduction with a homogeneous catalyst in ionic liquid: high catalytic activity at low overpotential.” The journal of physical chemistry letters 5.11 (2014): 2033-2038.
54. Lim, Hyung-Kyu, and Hyungjun Kim. “The mechanism of room-temperature ionic-liquid-based electrochemical CO₂ reduction: a review.” Molecules 22.4 (2017): 536.
55. Xu, Yi, et al. “Oxygen-tolerant electroproduction of C2 products from simulated flue gas.” Energy & Environmental Science 13.2 (2020): 554-561.
56. De Arquer, F. Pelayo García, et al. “CO₂ electrolysis to multicarbon products at activities greater than 1 A cm⁻².” Science 367.6478 (2020): 661-666.
57. Dinh, Cao-Thang, Yuguang C. Li, and Edward H. Sargent. “Boosting the single-pass conversion for renewable chemical electrosynthesis.” Joule 3.1 (2019): 13-15.
58. Salvatore, Danielle, and Curtis P. Berlinguette. “Voltage matters when reducing CO₂ in an electrochemical flow cell.” ACS Energy Letters 5.1 (2019): 215-220.
59. Ma, Wenchao, et al. “Electrocatalytic reduction of CO₂ to ethylene and ethanol through hydrogen-assisted C—C coupling over fluorine-modified copper.” Nature Catalysis 3.6 (2020): 478-487.
60. Chen, Xinyi, et al. “Electrochemical CO₂-to-ethylene conversion on polyamine-incorporated Cu electrodes.” Nature Catalysis 4.1 (2021): 20-27.
61. Li, Fengwang, et al. “Molecular tuning of CO₂-to-ethylene conversion.” Nature 577.7791 (2020): 509-513.
62. Chen, Kai-Jie, et al. “Synergistic sorbent separation for one-step ethylene purification from a four-component mixture.” Science 366.6462 (2019): 241-246.
63. Amooghin, Abtin Ebadi, et al. “Substantial breakthroughs on function-led design of advanced materials used in mixed matrix membranes (MMMs): a new horizon for efficient CO₂ separation.” Progress In Materials Science 102 (2019): 222-295.

1. A multilayer cathode for the electrochemical reduction of carbon dioxide comprising:
a gas diffusion layer;
a cathode catalyst layer disposed on the gas diffusion layer, and
a permeable carbon dioxide regeneration layer comprising an anion exchange ionomer disposed on the cathode catalyst layer.

2. The multilayer cathode of claim 1, further comprising a current collector adjacent to the gas diffusion layer.

3. The multilayer cathode of claim 1 or 2, wherein the gas diffusion layer comprises a porous material.

4. The multilayer cathode of claim 3, wherein the porous material is a fluoropolymer.

5. The multilayer cathode of claim 4, wherein the fluoropolymer is polytetrafluoroethylene or expanded polytetrafluoroethylene.

6. The multilayer cathode of any one of claims 1 to 5, wherein the gas diffusion layer is made of a polytetrafluoroethylene filter or a carbon paper substrate treated with polytetrafluoroethylene.

7. The multilayer cathode of any one of claims 1 to 4, wherein the gas diffusion layer has a porosity with pore size in the range of from about 0.01 μm to 2 μm, limits included.

8. The multilayer cathode of any one of claims 1 to 7, wherein the cathode catalyst layer comprises a cathode catalyst material that promotes the electrochemical reduction of carbon dioxide.

9. The multilayer cathode of claim 8, wherein the cathode catalyst material is selected from the group consisting of silver, copper, gold, nickel, tin, gallium, zinc, palladium, cadmium, indium, platinum, mercury, thallium, lead, bismuth, cobalt and an alloy comprising at least one thereof.

10. The multilayer cathode of claim 9, wherein the cathode catalyst material is copper or silver.

11. The multilayer cathode of any one of claims 1 to 10, wherein the cathode catalyst layer has a thickness in the range of from about 50 nm to about 500 nm, limits included.

12. The multilayer cathode of any one of claims 1 to 11, wherein the permeable carbon dioxide regeneration layer has a thickness in the range of from about 0.1 μm to about 10 μm, limits included.

13. The multilayer cathode of any one of claims 1 to 12, wherein the permeable carbon dioxide regeneration layer has an anion exchange ionomer loading in the range of from about 0.5 mg/cm² to about 3 mg/cm², limits included.

14. The multilayer cathode of any one of claims 1 to 13, wherein the permeable carbon dioxide regeneration layer has an ion exchange capacity in the range of from about 0.5 Meq/g to about 3 Meq/g, limits included.

15. The multilayer cathode of any one of claims 1 to 14, wherein the permeable carbon dioxide regeneration layer has a permselectivity in the range of from about 85% to about 100%, limits included.

16. The multilayer cathode of any one of claims 1 to 15, wherein the permeable carbon dioxide regeneration layer has a water uptake in the range of from about 10% to about 50%, limits included.

17. The multilayer cathode of any one of claims 1 to 16, wherein the permeable carbon dioxide regeneration layer has a conductivity in the range of from about 2 mS/cm to about 100 mS/cm, limits included.

18. A method of manufacturing a multilayer cathode for the electrochemical reduction of carbon dioxide comprising:
depositing a cathode catalyst material onto one side of a gas diffusion layer to provide a cathode catalyst layer thereon; and
coating an anion exchange ionomer solution onto the cathode catalyst layer to provide a permeable carbon dioxide regeneration layer.

19. The method of claim 18, further comprising affixing the other side of the gas diffusion layer on a current collector.

20. The method of claim 18 or 19, wherein depositing the cathode catalyst material onto the gas diffusion layer is performed by a physical vapor deposition method.

21. The method of claim 20, wherein the physical vapor deposition method is sputter deposition.

22. The method of any one of claims 18 to 21, wherein the gas diffusion layer comprises a porous material.

23. The method of claim 22, wherein the porous material comprises a fluoropolymer.

24. The method of claim 23, wherein the fluoropolymer is polytetrafluoroethylene or expanded polytetrafluoroethylene.

25. The method of any one of claims 18 to 24, wherein the gas diffusion layer is made of a polytetrafluoroethylene filter or a carbon paper substrate treated with polytetrafluoroethylene.

26. The method of any one of claims 18 to 25, wherein the gas diffusion layer has a porosity with pore size in the range of from about 0.01 μm to 2 μm, limits included.

27. The method of any one of claims 18 to 26, wherein the cathode catalyst material promotes the electrochemical reduction of carbon dioxide.

28. The method of claim 27, wherein the cathode catalyst material is selected from the group consisting of silver, copper, gold, nickel, tin, gallium, zinc, palladium, cadmium, indium, platinum, mercury, thallium, lead, bismuth, cobalt and an alloy comprising at least one thereof.

29. The method of claim 28, wherein the cathode catalyst material is copper or silver.

30. The method of any one of claims 18 to 29, wherein the cathode catalyst layer has a thickness in the range of from about 50 nm to about 500 nm, limits included.

31. The method of any one of claims 18 to 30, wherein the anion exchange ionomer solution comprises from about 0.34 wt. % to about 0.68 wt. % of the anion exchange ionomer, limits included.

32. The method of any one of claims 18 to 31, wherein the anion exchange ionomer solution is obtained by dissolving an anion exchange ionomer powder in an alcohol.

33. The method of claim 32, wherein the anion exchange ionomer powder is dissolved in the alcohol by sonication.

34. The method of claim 32 or 33, wherein the alcohol is methanol.

35. The method of any one of claims 18 to 34, wherein coating the anion exchange ionomer solution onto the cathode catalyst layer is performed by a spray deposition method.

36. The method of claim 35, wherein the spray deposition method is carried out a spraying rate in the range of from about 0.4 mL/h/cm² to about 1.6 mL/h/cm², limits included.

37. The method of any one of claims 18 to 36, wherein the permeable carbon dioxide regeneration layer has a thickness in the range of from about 0.1 μm to about 10 μm, limits included.

38. The method of any one of claims 18 to 37, wherein the permeable carbon dioxide regeneration layer has an anion exchange ionomer loading in the range of from about 0.5 mg/cm² to about 3 mg/cm², limits included.

39. The method of any one of claims 18 to 38, wherein the permeable carbon dioxide regeneration layer has an ion exchange capacity in the range of from about 0.5 Meq/g to about 3 Meq/g, limits included.

40. The method of any one of claims 18 to 39, wherein the permeable carbon dioxide regeneration layer has a permselectivity in the range of from about 85% to about 100%, limits included.

41. The method of any one of claims 18 to 40, wherein the permeable carbon dioxide regeneration layer has a water uptake in the range of from about 10% to about 50%, limits included.

42. The method of any one of claims 18 to 41, wherein the permeable carbon dioxide regeneration layer has a conductivity in the range of from about 2 mS/cm to about 100 mS/cm, limits included.

43. A membrane electrode assembly for the electrochemical reduction of carbon dioxide comprising:
a multilayer cathode comprising a gas diffusion layer, a cathode catalyst layer disposed on the gas diffusion layer, and a permeable carbon dioxide regeneration layer comprising an anion exchange ionomer disposed on the cathode catalyst layer;
an anode comprising an anode catalyst layer; and
at least one layer of a cation exchange membrane disposed between the permeable carbon dioxide regeneration layer and the anode catalyst layer.

44. The membrane electrode assembly of claim 43, wherein the multilayer cathode further comprises a current collector adjacent to the gas diffusion layer.

45. The membrane electrode assembly of claim 43 or 44, wherein the gas diffusion layer comprises a porous material.

46. The membrane electrode assembly of claim 45, wherein the porous material is a fluoropolymer.

47. The membrane electrode assembly of claim 46, wherein the fluoropolymer is polytetrafluoroethylene or expanded polytetrafluoroethylene.

48. The membrane electrode assembly of any one of claims 43 to 47, wherein the gas diffusion layer is made of a polytetrafluoroethylene filter or a carbon paper substrate treated with polytetrafluoroethylene.

49. The membrane electrode assembly of any one of claims 43 to 48, wherein the gas diffusion layer has a porosity with pore size in the range of from about 0.01 μm to 2 μm, limits included.

50. The membrane electrode assembly of any one of claims 43 to 49, wherein the cathode catalyst layer comprises a cathode catalyst material that promotes the electrochemical reduction of carbon dioxide.

51. The membrane electrode assembly of claim 50, wherein the cathode catalyst material is selected from the group consisting of silver, copper, gold, nickel, tin, gallium, zinc, palladium, cadmium, indium, platinum, mercury, thallium, lead, bismuth, cobalt and an alloy comprising at least one thereof.

52. The membrane electrode assembly of claim 51, wherein the cathode catalyst material is copper or silver.

53. The membrane electrode assembly of any one of claims 43 to 52, wherein the cathode catalyst layer has a thickness in the range of from about 50 nm to about 500 nm, limits included.

54. The membrane electrode assembly of any one of claims 43 to 53, wherein the permeable carbon dioxide regeneration layer has a thickness in the range of from about 0.1 μm to about 10 μm, limits included.

55. The membrane electrode assembly of any one of claims 43 to 54, wherein the permeable carbon dioxide regeneration layer has an anion exchange ionomer loading in the range of from about 0.5 mg/cm² to about 3 mg/cm², limits included.

56. The membrane electrode assembly of any one of claims 43 to 55, wherein the permeable carbon dioxide regeneration layer has an ion exchange capacity in the range of from about 0.5 Meq/g to about 3 Meq/g, limits included.

57. The membrane electrode assembly of any one of claims 43 to 56, wherein the permeable carbon dioxide regeneration layer has a permselectivity in the range of from about 85% to about 100%, limits included.

58. The membrane electrode assembly of any one of claims 43 to 57, wherein the permeable carbon dioxide regeneration layer has a water uptake in the range of from about 10% to about 50%, limits included.

59. The membrane electrode assembly of any one of claims 43 to 58, wherein the permeable carbon dioxide regeneration layer has a conductivity in the range of from about 2 mS/cm to about 100 mS/cm, limits included.

60. The membrane electrode assembly of any one of claims 43 to 59, wherein the anode further comprises a current collector adjacent to the anode catalyst layer.

61. The membrane electrode assembly of any one of claims 43 to 60, wherein the anode catalyst layer comprises an anode catalyst material that promotes electrochemical oxidation of water.

62. The membrane electrode assembly of claim 61, wherein the anode catalyst material is a metal oxide.

63. The membrane electrode assembly of claim 62, wherein the metal oxide is selected from the group consisting of iridium oxide, nickel oxide, iron oxide, cobalt oxide, nickel-iron oxide, iridium-ruthenium oxide and platinum oxide.

64. The membrane electrode assembly of claim 63, wherein the metal oxide is iridium dioxide.

65. The membrane electrode assembly of any one of claims 43 to 64, wherein the at least one layer of a cation exchange membrane is in contact with the permeable carbon dioxide regeneration layer and the anode catalyst layer.

66. The membrane electrode assembly of any one of claims 43 to 64, wherein said membrane electrode assembly is a bipolar membrane electrode assembly, and further comprises at least one layer of an anion exchange membrane disposed on the at least one layer of a cation exchange membrane and facing the anode catalyst layer.

67. A bipolar membrane electrode assembly for the electrochemical reduction of carbon dioxide comprising:
a multilayer cathode comprising a gas diffusion layer, a cathode catalyst layer disposed on the gas diffusion layer, and a permeable carbon dioxide regeneration layer comprising an anion exchange ionomer disposed on the cathode catalyst layer;
an anode comprising an anode catalyst layer; and
at least one layer of a cation exchange membrane and at least one layer of an anion exchange membrane disposed between the permeable carbon dioxide regeneration layer and the anode catalyst layer, wherein said at least one layer of a cation exchange membrane faces the permeable carbon dioxide regeneration layer and said at least one layer of an anion exchange membrane faces the anode catalyst layer.

68. The bipolar membrane electrode assembly of claim 67, wherein the multilayer cathode further comprises a current collector adjacent to the gas diffusion layer.

69. The bipolar membrane electrode assembly of claim 67 or 68, wherein the gas diffusion layer comprises a porous material.

70. The bipolar membrane electrode assembly of claim 69, wherein the porous material is a fluoropolymer.

71. The bipolar membrane electrode assembly of claim 70, wherein the fluoropolymer is polytetrafluoroethylene or expanded polytetrafluoroethylene.

72. The bipolar membrane electrode assembly of any one of claims 67 to 71, wherein the gas diffusion layer is made of a polytetrafluoroethylene filter or a carbon paper substrate treated with polytetrafluoroethylene.

73. The bipolar membrane electrode assembly of any one of claims 67 to 72, wherein the gas diffusion layer has a porosity with pore size in the range of from about 0.01 μm to 2 μm, limits included.

74. The bipolar membrane electrode assembly of any one of claims 67 to 73, wherein the cathode catalyst layer comprises a cathode catalyst material that promotes the electrochemical reduction of carbon dioxide.

75. The bipolar membrane electrode assembly of claim 74, wherein the cathode catalyst material is selected from the group consisting of gold, silver, copper, gold, nickel, tin, gallium, zinc, palladium, cadmium, indium, platinum, mercury, thallium, lead, bismuth, cobalt and an alloy comprising at least one thereof.

76. The bipolar membrane electrode assembly of claim 75, wherein the cathode catalyst material is copper or silver.

77. The bipolar membrane electrode assembly of any one of claims 67 to 76, wherein the cathode catalyst layer has a thickness in the range of from about 50 nm to about 500 nm, limits included.

78. The bipolar membrane electrode assembly of any one of claims 67 to 77, wherein the permeable carbon dioxide regeneration layer has a thickness in the range of from about 0.1 μm to about 10 μm, limits included.

79. The bipolar membrane electrode assembly of any one of claims 67 to 78, wherein the permeable carbon dioxide regeneration layer has an anion exchange ionomer loading in the range of from about 0.5 mg/cm² to about 3 mg/cm², limits included.

80. The bipolar membrane electrode assembly of any one of claims 67 to 79, wherein the permeable carbon dioxide regeneration layer has an ion exchange capacity in the range of from about 0.5 Meq/g to about 3 Meq/g, limits included.

81. The bipolar membrane electrode assembly of any one of claims 67 to 80, wherein the permeable carbon dioxide regeneration layer has a permselectivity in the range of from about 85% to about 100%, limits included.

82. The bipolar membrane electrode assembly of any one of claims 67 to 81, wherein the permeable carbon dioxide regeneration layer has a water uptake in the range of from about 10% to about 50%, limits included.

83. The bipolar membrane electrode assembly of any one of claims 67 to 82, wherein the permeable carbon dioxide regeneration layer has a conductivity in the range of from about 2 mS/cm to about 100 mS/cm, limits included.

84. The bipolar membrane electrode assembly of any one of claims 67 to 83, wherein the anode further comprises a current collector adjacent to the anode catalyst layer.

85. The bipolar membrane electrode assembly of any one of claims 67 to 84, wherein the anode catalyst layer comprises an anode catalyst material that promotes electrochemical oxidation of water.

86. The bipolar membrane electrode assembly of claims 67 to 85, wherein the anode catalyst material is a metal oxide.

87. The bipolar membrane electrode assembly of claims 67 to 86, wherein the metal oxide is selected from the group consisting of iridium oxide, nickel oxide, iron oxide, cobalt oxide, nickel-iron oxide, iridium-ruthenium oxide and platinum oxide.

88. The bipolar membrane electrode assembly of claim 87, wherein the metal oxide is iridium dioxide.

89. A method of manufacturing a membrane electrode assembly for the electrochemical reduction of carbon dioxide comprising:
depositing a cathode catalyst material onto one side of a gas diffusion layer to provide a cathode catalyst layer thereon;
coating an anion exchange ionomer solution onto the cathode catalyst layer to provide a permeable carbon dioxide regeneration layer;
placing at least one layer of a cation exchange membrane onto the permeable carbon dioxide regeneration layer; and
placing an anode comprising on one side an anode catalyst material onto the at least one layer of a cation exchange membrane, said anode catalyst material facing the at least one layer of a cation exchange membrane.

90. The method of claim 89, further comprising affixing the other side gas diffusion layer on a current collector.

91. The method of claim 89 or 90, wherein depositing the cathode catalyst material onto the gas diffusion layer is performed by a physical vapor deposition method.

92. The method of claim 91, wherein the physical vapor deposition method is sputter deposition.

93. The method of any one of claims 89 to 92, wherein the gas diffusion layer comprises a porous material.

94. The method of claim 93, wherein the porous material comprises a fluoropolymer.

95. The method of claim 94, wherein the fluoropolymer is polytetrafluoroethylene or expanded polytetrafluoroethylene.

96. The method of any one of claims 89 to 95, wherein the gas diffusion layer is made of a polytetrafluoroethylene filter or a carbon paper substrate treated with polytetrafluoroethylene.

97. The method of any one of claims 89 to 96, wherein the gas diffusion layer has a porosity with pore size in the range of from about 0.01 μm to 2 μm, limits included.

98. The method of any one of claims 89 to 97, wherein the cathode catalyst material promotes the electrochemical reduction of carbon dioxide.

99. The method of claim 98, wherein the cathode catalyst material is selected from the group consisting of silver, copper, gold, nickel, tin, gallium, zinc, palladium, cadmium, indium, platinum, mercury, thallium, lead, bismuth, cobalt and an alloy comprising at least one thereof.

100. The method of claim 99, wherein the cathode catalyst material is copper or silver.

101. The method of any one of claims 89 to 100, wherein the cathode catalyst layer has a thickness in the range of from about 50 nm to about 500 nm, limits included.

102. The method of any one of claims 89 to 101, wherein the anion exchange ionomer solution comprises from about 0.34 wt. % to about 0.68 wt. % of the anion exchange ionomer, limits included.

103. The method of any one of claims 89 to 102, wherein the anion exchange ionomer solution is obtained by dissolving an anion exchange ionomer powder in an alcohol.

104. The method of claim 103, wherein the anion exchange ionomer powder is dissolved in the alcohol by sonication.

105. The method of claim 103 or 104, wherein the alcohol is methanol.

106. The method of any one of claims 89 to 105, wherein coating the anion exchange ionomer solution onto the cathode catalyst layer is performed by a spray deposition method.

107. The method of claim 106, wherein the spray deposition method is carried out a spraying rate in the range of from about 0.4 mL/h/cm² to about 1.6 mL/h/cm², limits included.

108. The method of any one of claims 89 to 107, wherein the permeable carbon dioxide regeneration layer has a thickness in the range of from about 0.1 μm to about 10 μm, limits included.

109. The method of any one of claims 89 to 108, wherein the permeable carbon dioxide regeneration layer has an anion exchange ionomer loading in the range of from about 0.5 mg/cm² to about 3 mg/cm², limits included.

110. The method of any one of claims 89 to 109, wherein the permeable carbon dioxide regeneration layer has an ion exchange capacity in the range of from about 0.5 Meq/g to about 3 Meq/g, limits included.

111. The method of any one of claims 89 to 110, wherein the permeable carbon dioxide regeneration layer has a permselectivity in the range of from about 85% to about 100%, limits included.

112. The method of any one of claims 89 to 111, wherein the permeable carbon dioxide regeneration layer has a water uptake in the range of from about 10% to about 50%, limits included.

113. The method of any one of claims 89 to 112, wherein the permeable carbon dioxide regeneration layer has a conductivity in the range of from about 2 mS/cm to about 100 mS/cm, limits included.

114. The method of any one of claims 89 to 113, the membrane electrode assembly is a bipolar membrane electrode assembly, having the at least one layer of a cation exchange membrane facing the permeable carbon dioxide regeneration layer and at least one layer of an anion exchange membrane facing the anode catalyst material.

115. The method of any one of claims 89 to 114, further comprising affixing the other side anode on a current collector.

116. A method of manufacturing a bipolar membrane electrode assembly for the electrochemical reduction of carbon dioxide comprising:
depositing a cathode catalyst material onto one side of a gas diffusion layer to provide a cathode catalyst layer thereon;
coating an anion exchange ionomer solution onto the cathode catalyst layer to provide a permeable carbon dioxide regeneration layer;
placing at least one layer of a cation exchange membrane onto the permeable carbon dioxide regeneration layer;
placing at least one layer of an anion exchange membrane onto the at least one layer of a cation exchange membrane; and
placing an anode comprising on one side an anode catalyst material onto the at least one layer of an anion exchange membrane, said anode catalyst material facing the at least one layer of an anion exchange membrane.

117. The method of claim 116, further comprising affixing the other side gas diffusion layer on a current collector.

118. The method of claim 116 or 117, wherein depositing the cathode catalyst material onto the gas diffusion layer is performed by a physical vapor deposition method.

119. The method of claim 118, wherein the physical vapor deposition method is sputter deposition.

120. The method of any one of claims 116 to 119, wherein the gas diffusion layer comprises a porous material.

121. The method of claim 120, wherein the porous material comprises a fluoropolymer.

122. The method of claim 121, wherein the fluoropolymer is polytetrafluoroethylene or expanded polytetrafluoroethylene.

123. The method of any one of claims 116 to 122, wherein the gas diffusion layer is made of a polytetrafluoroethylene filter or a carbon paper substrate treated with polytetrafluoroethylene.

124. The method of any one of claims 116 to 123, wherein the gas diffusion layer has a porosity with pore size in the range of from about 0.01 μm to 2 μm, limits included.

125. The method of any one of claims 116 to 124, wherein the cathode catalyst material promotes the electrochemical reduction of carbon dioxide.

126. The method of claim 125, wherein the cathode catalyst material is selected from the group consisting of silver, copper, gold, nickel, tin, gallium, zinc, palladium, cadmium, indium, platinum, mercury, thallium, lead, bismuth, cobalt and an alloy comprising at least one thereof.

127. The method of claim 126, wherein the cathode catalyst material is copper or silver.

128. The method of any one of claims 116 to 127, wherein the cathode catalyst layer has a thickness in the range of from about 50 nm to about 500 nm, limits included.

129. The method of any one of claims 116 to 128, wherein the anion exchange ionomer solution comprises from about 0.34 wt. % to about 0.68 wt. % of the anion exchange ionomer, limits included.

130. The method of any one of claims 116 to 129, wherein the anion exchange ionomer solution is obtained by dissolving an anion exchange ionomer powder in an alcohol.

131. The method of claim 130, wherein the anion exchange ionomer powder is dissolved in the alcohol by sonication.

132. The method of claim 130 or 131, wherein the alcohol is methanol.

133. The method of any one of claims 116 to 132, wherein coating the anion exchange ionomer solution onto the cathode catalyst layer is performed by a spray deposition method.

134. The method of claim 133, wherein the spray deposition method is carried out a spraying rate in the range of from about 0.4 mL/h/cm² to about 1.6 mL/h/cm², limits included.

135. The method of any one of claims 116 to 134, wherein the permeable carbon dioxide regeneration layer has a thickness in the range of from about 0.1 μm to about 10 μm, limits included.

136. The method of any one of claims 116 to 135, wherein the permeable carbon dioxide regeneration layer has an anion exchange ionomer loading in the range of from about 0.5 mg/cm² to about 3 mg/cm², limits included.

137. The method of any one of claims 116 to 136, wherein the permeable carbon dioxide regeneration layer has an ion exchange capacity in the range of from about 0.5 Meq/g to about 3 Meq/g, limits included.

138. The method of any one of claims 116 to 137, wherein the permeable carbon dioxide regeneration layer has a permselectivity in the range of from about 85% to about 100%, limits included.

139. The method of any one of claims 116 to 138, wherein the permeable carbon dioxide regeneration layer has a water uptake in the range of from about 10% to about 50%, limits included.

140. The method of any one of claims 116 to 139, wherein the permeable carbon dioxide regeneration layer has a conductivity in the range of from about 2 mS/cm to about 100 mS/cm, limits included.

141. Use of the multilayer cathode as defined in any one of claims 1 to 17 or produced by the method as defined in any one of claims 18 to 42, for the production of a multicarbon product.

142. Use of the membrane electrode assembly as defined in any one of claims 43 to 66 or produced by the method as defined in any one of claims 89 to 115, for the production of a multicarbon product.

143. Use of the bipolar membrane electrode assembly as defined in any one of claims 67 to 88 or produced by the method as defined in any one of claims 116 to 140, for the production of a multicarbon product.

144. The use of any one of claims 142 to 143, wherein the multicarbon product is ethylene or ethanol.

145. A method for electrochemical production of a multicarbon product using the bipolar membrane electrode assembly as defined in any one of claims 67 to 88, the method comprising the steps of:
contacting carbon dioxide and an electrolyte with the multilayer cathode, such that the carbon dioxide diffuses through the gas diffusion layer and contacts the cathode catalyst layer;
applying a voltage to provide a current density to cause the carbon dioxide contacting the cathode catalyst layer to be electrochemically reduced into the multicarbon product; and
recovering the multicarbon product.

146. The method of claim 145, wherein carbonate ions are produced when applying the voltage.

147. The method of claim 146, wherein carbon dioxide is regenerated from the carbonate ions in the permeable carbon dioxide regeneration layer.

148. The method of claim 147, wherein the regenerated carbon dioxide is transported to the cathode catalyst layer to be electrochemically reduced into the multicarbon product prior to the recovering step.

149. The method of any one of claims 145 to 148, wherein the multicarbon product is ethylene or ethanol.

150. A method for electrochemical production of a multicarbon product using the membrane electrode assembly as defined in any one of claims 43 to 66, the method comprising the steps of:
contacting carbon dioxide and an electrolyte with the multilayer cathode, such that the carbon dioxide diffuses through the gas diffusion layer and contacts the cathode catalyst layer;
applying a voltage to provide a current density to cause the carbon dioxide contacting the cathode catalyst layer to be electrochemically reduced into the multicarbon product; and
recovering the multicarbon product.

151. The method of claim 150, wherein carbonate ions are produced when applying the voltage.

152. The method of claim 151, wherein carbon dioxide is regenerated from the carbonate ions in the permeable carbon dioxide regeneration layer.

153. The method of claim 152, wherein the regenerated carbon dioxide is transported to the cathode catalyst layer to be electrochemically reduced into the multicarbon product prior to the recovering step.

154. The method of any one of claims 150 to 153, wherein the multicarbon product is ethylene or ethanol.
